(19) United States
(12) Patent Application Publication
(10) Pub. No.: US 2024/0428714 A1
(43) Pub. Date: Dec. 26, 2024

(54) GAMMA LINE INTERCONNECT CIRCUIT AND DISPLAY DRIVE CIRCUIT INCLUDING THEREOF

(71) Applicant: SAMSUNG ELECTRONICS CO., LTD., Suwon-si (KR)

(72) Inventors: Donghan LEE, Suwon-si (KR); Nahoo Lee, Suwon-si (KR); Jeonghyun Ju, Suwon-si (KR)

(73) Assignee: SAMSUNG ELECTRONICS CO., LTD., Suwon-si (KR)

(21) Appl. No.: 18/387,715

(22) Filed: Nov. 7, 2023

(30) Foreign Application Priority Data
Jun. 26, 2023 (KR) 10-2023-0082146

(51) Int. Cl. G09G 3/20

(52) U.S. Cl. CPC G09G 3/20; G09G 2300/0426; G09G 2310/0291; G09G 2320/0673

(57) ABSTRACT

According to an embodiment of the present disclosure, gamma line interconnect circuit may include a resistor string including a first resistor connected between a first node and a second node and a second resistor connected between the second node and a third node, a first switch connected between a first gamma line and the first node, and configured to operate based on an interconnect signal, a second switch connected between a second gamma line and the second node, and configured to operate based on the interconnect signal, and a third switch that is connected between a third gamma line and the third node, and configured to operate based on the interconnect signal.

### CROSS-REFERENCE TO RELATED APPLICATION

This application claims priority to and the benefit of Korean Patent Application No. 10-2023-0082146 filed on Jun. 26, 2023 in the Korean Intellectual Property Office, the entire contents of which are incorporated herein by reference.

### BACKGROUND

### (a) Field

The present disclosure relates to a display device. More particularly, it relates to a gamma line interconnect circuit and a display drive circuit including the same.

### (b) Description of the Related Art

A display device may include a display panel including a plurality of pixels, and a display drive circuit. The display drive circuit may control the display panel through a plurality of source drive circuits. For example, each source drive circuit may control gray levels of pixels of the display panel based on a gamma voltage received through a gamma line.

When the source drive circuit changes a gray level of a pixel, a voltage level swing (e.g., glitch) may occur in a voltage level of the gamma line. In particular, according to the recent trend of high-resolution and higher integration of display devices, the time required to recover the gamma line voltage level swing that occurs when changing the gray level of the pixel is gradually increasing due to a parasitic resistance of the gamma line. Accordingly, it is becoming increasingly difficult for the display drive circuit to drive the display panel at high speed.

In addition, when a swing occurs in the voltage level of the gamma line, an error may also occur in an output of the source drive circuit operating based on the gamma line where the voltage level swing occurs. In this case, an error may also occur in an image displayed by the display panel operating based on the output of the source drive circuit.

### SUMMARY

The present disclosure is to solve the above-stated technical object. More particularly, the present disclosure is to provide a gamma line interconnect circuit that minimizes the effect on gray level adjustment of gamma line parasitic resistance, and a display drive circuit including the same.

According to an embodiment of the present disclosure, gamma line interconnect circuit may be provided. The gamma line interconnect circuit may comprise a resistor string including a first resistor connected between a first node and a second node and a second resistor connected between the second node and a third node, a first switch connected between a first gamma line and the first node, and configured to operate based on an interconnect signal, a second switch connected between a second gamma line and the second node, and configured to operate based on the interconnect signal, and a third switch that is connected between a third gamma line and the third node, and configured to operate based on the interconnect signal.

According to an embodiment of the present disclosure, display driver circuit may be provided. The display driver circuit may comprise a source drive circuit controlling a display panel; a gamma voltage generator respectively providing a first to N-th gamma voltages to a first to N-th gamma lines connected to the source drive circuit, wherein N is an integer greater than 2; and a gamma line interconnect circuit interconnecting the first to N-th gamma lines for a first time period from a first time point when a gray level value of the source drive circuit is changed.

According to an embodiment of the present disclosure, display device may be provided. The display device may comprise a display panel including a first plurality of pixels and a second plurality of pixels, and a display drive circuit controlling the first plurality of pixels and the second plurality of pixels. Wherein the display drive circuit comprises, a gamma voltage generator providing different gamma voltages to a plurality of gamma lines, a first source drive circuit array connected with the plurality of gamma lines, and including a first plurality of source drive circuits configured to control the first plurality of pixels, a second source drive circuit array connected with the plurality of gamma lines, and including a second plurality of source drive circuits configured to control the second plurality of pixels, and a gamma line interconnect circuit located between the first source drive circuit array and the second source drive circuit array, and interconnecting the plurality of gamma lines during a predetermined time period after a change in one or more gray level values of the first plurality of source drive circuits and the second plurality of source drive circuits.

### BRIEF DESCRIPTION OF THE DRAWINGS

FIG. 1 is a block diagram that shows a display device according to an embodiment of the present disclosure.

FIG. 2 is a block diagram that shows some configuration of the display drive circuit of FIG. 1 in more detail.

FIG. 3A and FIG. 3B show a configuration and operation of one of the source drive circuits of FIG. 2 in more detail.

FIG. 4 is a graph that shows a voltage level of the victim gamma line of FIG. 3A and FIG. 3B.

FIG. 5 shows a block diagram that shows the operation of the gamma line interconnect circuit of FIG. 1.

FIG. 6 is a circuit diagram of the gamma line interconnect circuit of FIG. 5 according to an embodiment of the present disclosure.

FIG. 7A and FIG. 7B show equivalent resistance between the source driver and the gamma voltage generator according to an operation mode of the gamma line interconnect circuit.

FIG. 8 shows the operation of the gamma line interconnect circuit and a voltage level of the victim gamma line according to an embodiment of the present disclosure.

FIG. 9 shows the source drive circuits connected to the gamma lines according to an embodiment of the present disclosure.

FIG. 10 shows a voltage level of the second output signal according to the operation of the gamma line interconnect circuit of FIG. 9.

FIG. 11 shows an operation method of the gamma line interconnect circuit of FIG. 1.

FIG. 12A to FIG. 12C respectively show configurations of a gamma line interconnect circuit implemented according to an embodiment.

FIG. 13 shows a configuration of the gamma line interconnect circuit implemented according to an embodiment.

FIG. 14 is a circuit diagram that shows the current provide circuit of FIG. 13.

FIG. 15 exemplarily illustrates a partial configuration of the gamma voltage generator of FIG. 1.

FIG. 16 is a circuit diagram that shows a configuration of the gamma line interconnect circuit FIG. 5 according to another embodiment of the present disclosure.

FIG. 17 shows a dispose layout of the display drive circuit according to an embodiment.

FIG. 18 shows a dispose layout of a display drive circuit according to an embodiment.

FIG. 19 shows a dispose layout of the display drive circuit according to an embodiment of the present disclosure.

FIG. 20 shows a voltage level swing of a victim gamma line according to the layout described with reference to FIG. 17 to FIG. 19.

FIG. 21 shows an output signal of the source drive circuit of which a gray level is changed according to the layout described with reference to FIG. 17 to FIG. 19.

FIG. 22 shows a dispose layout of a display drive circuit according to an embodiment of the present disclosure.

FIG. 23 shows a dispose layout of a display drive circuit according to an embodiment of the present disclosure.

FIG. 24 shows a configuration of a gamma line interconnect circuit according to another embodiment of the present disclosure.

### DETAILED DESCRIPTION OF THE EMBODIMENTS

Hereinafter, embodiments of present disclosure will be described clearly and in detail to the extent that a person of an ordinary skill in the technical field of the present disclosure can easily practice the present disclosure. Details such as detailed configurations and structures are provided merely to facilitate a general understanding of the embodiments of the present disclosure. Therefore, variations of the embodiments described in the text can be performed by a person of an ordinary skill in the art without departing from the technical spirit and range of the present disclosure. Moreover, descriptions of well-known functions and structures are omitted for clarity and conciseness. Components in the following drawings or detailed description may be connected to other elements other than the constituent elements shown in the drawing or described in the detailed description. The terms used in the present disclosure are terms defined in consideration of the functions of the present disclosure, and are not limited to specific functions. The definition of terms can be determined based on the details described in the detailed description.

Constituent elements described with reference to terms such as driver or block used in the detailed description may be implemented in the form of software, hardware, or a combination thereof. Illustratively, software may be a machine code, firmware, an embedded code, and application software. For example, the hardware may include an electric circuit, an electronic circuit, a processor, a computer, integrated circuit cores, a pressure sensor, an inertial sensor, a micro electro mechanical system (MEMS), a passive element, or a combination thereof.

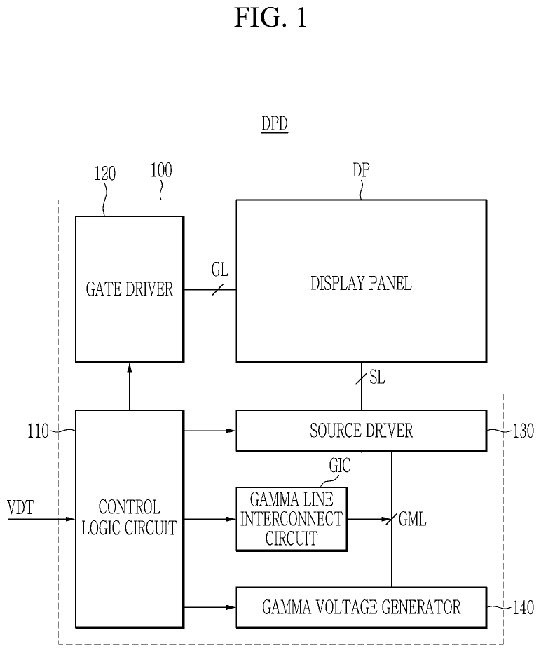

FIG. 1 is a block diagram that shows a display device according to an embodiment of the present disclosure. Referring to FIG. 1, a display device DPD may include a display drive circuit 100 and a display panel DP. The display device DPD may be included in an electronic device configured to display image information, such as a monitor, TV, laptop, tablet PC, a smart phone, navigation, and the like.

The display panel DP may include a plurality of pixels connected to a plurality of gate lines GL and a plurality of source lines SL. Each of the plurality of pixels may display one of primary colors in response to an electrical signal provided from the display drive circuit 100. The primary color may include red, green, and blue. However, the scope of the present disclosure is not limited thereto.

In an embodiment, a display panel DP may be one of various types of panels such as a liquid crystal display panel, an organic light emitting display panel, an electrophoretic display panel, an electrowetting display panel, and the like. However, the scope of the present disclosure is not limited thereto.

A display drive circuit 100 may include a control logic circuit 110, a gate driver 120, a source driver 130, a gamma voltage generator 140, and a gamma line interconnect circuit (GIC).

The control logic circuit 110 may receive video data (VDT) from an external source. For example, the control logic circuit 110 may receive the video data VDT from various types of electronic devices such as an application processor (AP), a graphic processing unit (GPU), and the like. In this case, the video data VDT may include data for controlling each of a plurality of pixels of the display panel DP.

The gate driver 120 may be connected with the display panel DP through a plurality of gate lines GL. The gate driver 120 may control the plurality of gate lines GL in response to the control of the control logic circuit 110.

The source driver 130 may be connected with the display panel DP through a plurality of source lines SL. The source driver 130 may be connected with the gamma voltage generator 140 through a plurality of gamma lines (GML).

The gamma voltage generator 140 may generate a plurality of gamma voltages in response to the control of the control logic circuit 110. The gamma voltage generator 140 may provide the plurality of gamma voltages to the plurality of gamma lines GML, respectively. In this case, the plurality of gamma voltages may correspond to different gray levels (e.g., different shades of gray). For example, when there are 256 different gray levels, ranging from pure black (level 0) to pure white (level 255), the plurality of gamma voltages may correspond to the 256 different gray levels, respectively. The term “gray level” may be also referred to as “luminance level” as the gray level indicates how bright or dark a pixel should be.

In an embodiment, the gamma voltage may be referred to as a gray voltage. However, the scope of the present disclosure is not limited thereto.

The source driver 130 may control the plurality of source lines SL in response to the control of the control logic circuit 110. For example, the source driver 130 may include a plurality of source drive circuits that respectively control the plurality of source lines SL.

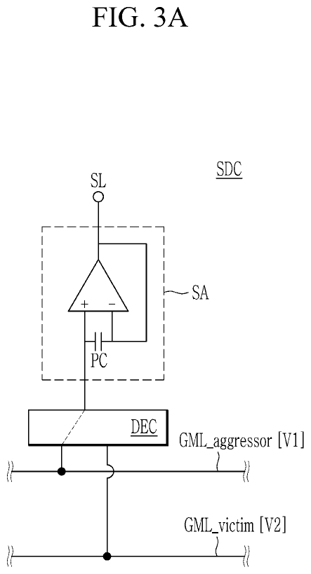

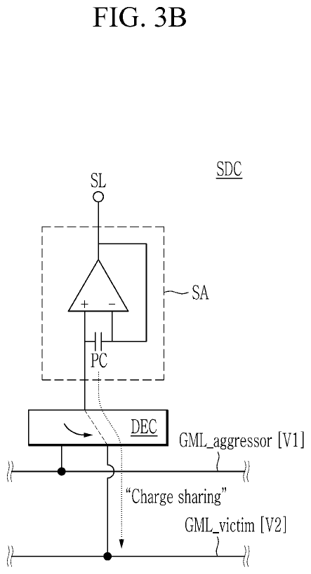

The plurality of source drive circuits may be respectively connected with the plurality of gamma lines GML. Each of the plurality of source drive circuits may determine a gray level of an output signal to be provided to a pixel based on a gray level value provided from the control logic circuit 110. For example, each of the plurality of source drive circuits may generate an output signal to be provided to a source line SL connected thereto, based on a gamma voltage (i.e., a voltage provided from one of the plurality of gamma lines GML) corresponding to the gray level value provided from the control logic circuit 110. That is, each of the plurality of source drive circuits may select one of the plurality of gamma voltages provided through the plurality of gamma lines GML in response to the gray level value provided from the control logic circuit 110, and may operate based on the selected gamma voltage. A more detailed operation of the source drive circuit will be described in more detail with reference to FIG. 3A to FIG. 3B.

In an embodiment, the plurality of source drive circuits may share the plurality of gamma lines. For example, a first source drive circuit may be connected to the same gamma line as a second source drive circuit.

In an embodiment, when a gray level value provided to the first source drive circuit is changed, and consequently, a gamma voltage used to generate an output signal by the first source drive circuit changes from a voltage of a first gamma line to a voltage of a second gamma line, a voltage fluctuation (e.g., swing or glitch) may occur in the voltage of the second gamma line. In this case, the voltage fluctuation may also occur in an output signal generated by the second source drive circuit, which operates based on the voltage of the second gamma line. And since it takes a certain amount of time for the output signal of the second source drive circuit to stabilize, the operation speed of a display device DPD may be deteriorated. Hereinafter, specific embodiments of minimizing the influence of the gamma line voltage fluctuation will be described.

The gamma line interconnect circuit GIC may interconnect the plurality of gamma lines GML. For example, the gamma line interconnect circuit GIC may establish connections between the plurality of gamma lines GML through a resistor. In this case, a resistance-capacitance (RC) time constant between the source driver 130 and the gamma voltage generator 140 may be reduced. Thus, according to an embodiment of the present disclosure, a voltage level fluctuation of the gamma line can be minimized.

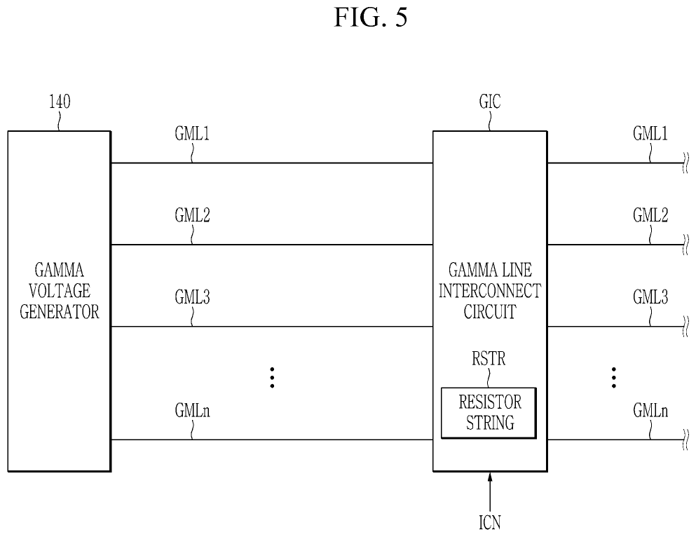

In an embodiment, the gamma line interconnect circuit GIC may be formed to interconnect the plurality of gamma lines GML only for a predetermined time period following a change in the gray level value provided to a part of the plurality of source drive circuit. That is, the gamma line interconnect circuit GIC may be formed to release or disengage the interconnection of the plurality of gamma line GML after the predetermined time elapses. In this case, voltage level distortion of the plurality of gamma lines GML due to interconnection between the plurality of gamma lines GML may be minimized. A detailed configuration and operation of the gamma line interconnect circuit GIC will be described in more detail with reference to FIG. 5 to FIG. 8.

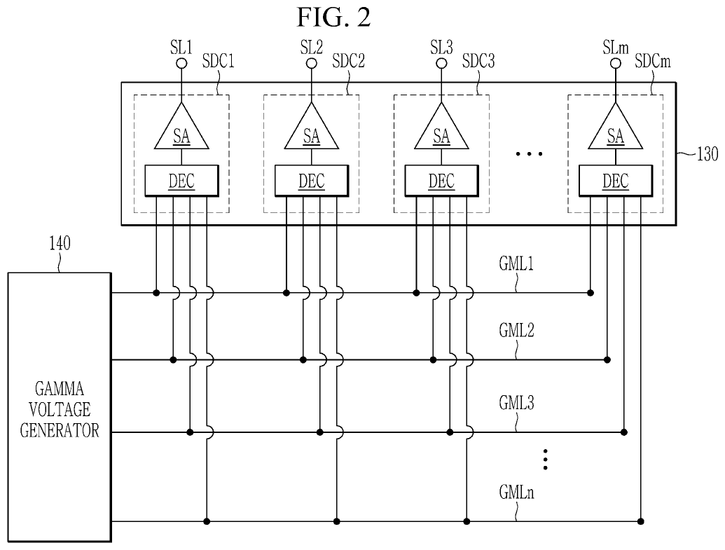

FIG. 2 is a block diagram that shows some configuration of the display drive circuit of FIG. 1 in more detail. Referring to FIG. 1 and FIG. 2, the gamma voltage generator 140 may be connected with the plurality of gamma lines GML. For example, the gamma voltage generator 140 may be connected with a first gamma line GML1 to an n-th gamma line GMLn.

The gamma voltage generator 140 may provide difference voltages to the first gamma line GML1 to the n-th gamma line GMLn. Hereinafter, for a more concise description, voltages provided to the first gamma line GML1 to the n-th gamma line GMLn will be referred to as first to nth gamma voltages, respectively. However, the scope of the present disclosure is not limited thereto.

The source driver 130 may include a first source drive circuit SDC1 to an m-th source drive circuit SDCm. The first source drive circuit SDC1 to the m-th source drive circuit SDCm may be respectively connected with a first source lines SL1 to an m-th source line SLm.

Each of the first source drive circuit SDC1 to the m-th source drive circuit SDCm may include a source amplifier SA and a decoder DEC.

Hereinafter, for a more concise description, the operation of the source amplifier SA and decoder DEC of the first source drive circuit SDC1 will be representatively described. However, the range of present disclosure is not limited thereto, and the second to m source drive circuits SDC2 to SDCm may also operate in a similar manner.

The decoder DEC of the first source drive circuit SDC1 may be connected with the first first gamma line GML1 to the n-th gamma line GMLn. The decoder DEC of the first source drive circuit SDC1 may select one of the first gamma line GML1 to the n-th gamma line GMLn in response to the control of the control logic circuit 110. For example, the decoder DEC of the first source drive circuit SDC1 may select one of the first gamma line GML1 to the n-th gamma line GMLn according to a gray level value received from the control logic circuit 110.

The decoder DEC of the first source drive circuit SDC1 may generate an input signal to be provided to the source amplifier SA based on a gamma voltage provided from the selected gamma line. In this case, the source amplifier SA may provide an output signal to the first source line SL1 based on the received input signal.

Hereinafter, for a more concise explanation, the gray level value provided by the control logic circuit 110 to the source drive circuit will be referred to as a gray level of the source drive circuit. However, the scope of the present disclosure is not limited to these terms.

Meanwhile, when the gray level of the first source drive circuit SDC1 is changed, the decoder DEC of the first source drive circuit SDC1 may select a gamma line corresponding to the changed gray level among the first gamma line GML1 to the n-th gamma line GMLn. In this case, the source amplifier SA of the first source drive circuit SDC1 may provide the output signal generated based on the gamma voltage provided from the selected gamma line (i.e., a gamma line corresponding to the changed gray level) to the first source line SL1.

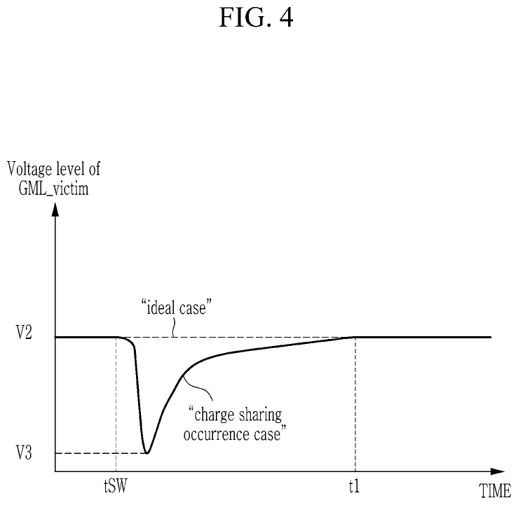

In an embodiment, when the gray level of the first source drive circuit SDC1 is changed, a swing may occur in a voltage level of a gamma line corresponding to the changed gray level. The voltage level swing of the gamma line occurring due to a change in the gray level of the source drive circuit will be described in more detail with reference to FIG. 3A and FIG. 3B, and FIG. 4.

In an embodiment, “n” may correspond to the number of gray levels supported by the display device DPD, and “m” may correspond to columns of pixels arranged in the display panel DP. However, the scope of the present disclosure is not limited thereto.

FIG. 3A and FIG. 3B show a configuration and operation of one of the source drive circuits of FIG. 2 in more detail. Hereinafter, referring to FIG. 3A, the configuration and operation of the source drive circuit before the gray level is changed will be described, and referring to FIG. 3B, the configuration and operation of the source drive circuit after the gray level is changed will be described. In addition, hereinafter, a source drive circuit SDC is assumed to one of the first source drive circuit SDC1 to the m-th source drive circuit SDCm of FIG. 2. However, the scope of the present disclosure is not limited thereto.

First, referring to FIG. 1 to FIG. 3A, the source drive circuit SDC may include the source amplifier SA and the decoder DEC. The source amplifier SA may include an operational amplifier. In particular, an output terminal of the operation amplifier may be connected with the source line SL, an inverting input terminal may be connected to the output terminal of the operational amplifier, and a non-inverting input terminal may be connected to the decoder DEC.

Before the gray level change, a gray level of the source drive circuit SDC may correspond to a voltage level of an aggressor gamma line GML_aggressor. That is, the source drive circuit SDC may operate based on a voltage of the aggressor gamma line GML_aggressor. For example, the decoder DEC may generate an input signal to be supplied to the source amplifier SA based on the gamma voltage “V1” provided from the aggressor gamma line GML_aggressor. In this case, the source amplifier SA may generate an output signal to be provided to the source line SL based on the input signal provided from the decoder DEC.

Parasitic capacitance PC may exist between the inverting input terminal and the non-inverting input terminal of the operation amplifier. Accordingly, when the decoder DEC provides the input signal to the source amplifier SA, a voltage corresponding to the gamma voltage V1 provided from the aggressor gamma line GML_aggressor may be charged in the parasitic capacitance PC.

Continuously referring to FIG. 3B, the gray level of the source drive circuit SDC may be changed to correspond to a voltage level of a victim gamma line GML_victim. That is, after the gray level change, the source drive circuit SDC may operate based on the voltage of the victim gamma line GML_victim instead of the aggressor gamma line GML_aggressor. In this case, the decoder DEC may generate an input signal to be provided to the source amplifier SA based on the gamma voltage “V2” provided from the victim gamma line GML_victim. The source amplifier SA may generate an output to be provided to the source line SL based on the input signal provided from the decoder DEC.

However, when the gray level of the source drive circuit SDC is changed from the gamma voltage V1 corresponding to the aggressor gamma line GML_aggressor to the gamma voltage V2 corresponding to the victim gamma line GML_victim, the “charge sharing” phenomenon may occur due to the charge stored in the parasitic capacitance PC because the parasitic capacitance PC acts as a pathway for charge to flow between the two input terminals of the amplifier. For example, when the decoder DEC changes a gray level voltage for generating the input signal to be provided to the source amplifier SA to the voltage of the victim gamma line GML_victim from the voltage of the aggressor gamma line GML_aggressor, a swing or fluctuation may occur in the voltage level of the victim gamma line GML_victim due to the charge stored in the parasitic capacitance PC. The voltage change may lead to a temporary redistribution of charge in the parasitic capacitance PC. The redistribution of charge may create an unintended voltage drop or rise across the parasitic capacitance PC, causing voltage fluctuations in the voltage level of the victim gamma line GML_victim. The voltage fluctuations may introduce noise or distortion in an output signal of the amplifier. The voltage level swing of the victim gamma line GML_victim will be described in more detail with reference to FIG. 4.

In an embodiment, each of the aggressor gamma line GML_aggressor and the victim gamma line GML_victim may be one of the first gamma line GML1 to the n-th gamma line GMLn.

FIG. 4 is a graph that shows a voltage level of the victim gamma line of FIG. 3A and FIG. 3B. In FIG. 4, the horizontal axis of the graph denotes time and the vertical axis of the graph denotes a voltage level of the victim gamma line GML_victim. Referring to FIG. 1 to FIG. 4, the gray level of the source drive circuit SDC may be changed at a switching time point tSW. For example, the gray level of the source drive circuit SDC may be changed to correspond to the voltage level of to the victim gamma line GML_victim, at the switching time point tSW.

In an embodiment, the switching time point tSW may be included in a horizontal blank period during which the gate driver 120 changes an active row of the display panel DP. However, the range of present disclosure is not limited thereto.

In the ideal case (e.g., when there is no parasitic capacitance PC), the voltage level of the victim gamma line GML_victim before and after the switching time point tSW may be maintained constant at “V2” (shown as a dotted line). In this case, a source drive circuit operating with a gray level corresponding to the victim gamma line GML_victim among the first source drive circuit SDC1 to the m-th source drive circuit SDCm may provide a uniform or consistent output signal to the source line.

On the other hand, as previously described with reference to FIG. 3A and FIG. 3B, when the charging sharing occurs (i.e., when the parasitic capacitance PC exists), a swing may occur in the voltage level of the victim gamma line GML_victim after the switching time point tSW (shown by the solid line). For example, the voltage level of the victim gamma line GML_victim may be decreased to “V3”, which is lower than “V2” after the switching time point tSW, and then may be increased again. In this case, source drive circuits that operate with a gray level corresponding to the victim gamma line GML_victim may fail to provide a uniform or consistent output signal to the source line until a first time point t1 (at which the voltage level of the victim gamma line GML_victim is restored to “V2”) from the switching time point tSW.

FIG. 5 shows a block diagram that shows the operation of the gamma line interconnect circuit of FIG. 1. Referring to FIG. 1 to FIG. 5, the gamma line interconnect circuit GIC may include a resistor string RSTR. The resistor string RSTR may include a plurality of resistors.

In an embodiment, the plurality of resistors included in the resistor string RSTR may be connected in series. However, the scope of the present disclosure is not limited thereto.

The gamma line interconnect circuit GIC may interconnect the first gamma line GML1 to the n-th gamma line GMLn in response to an interconnect signal ICN. For example, when the interconnect signal ICN is at a logic high state, the gamma line interconnect circuit GIC may operate in a coarse restore mode. In this case, the gamma line interconnect circuit GIC may interconnect the first gamma line GML1 to the n-th gamma line GMLn. More particularly, the gamma line interconnect circuit GIC may connect the first gamma line GML1 to the n-th gamma line GMLn to different nodes of the resistor string RSTR, respectively.

On the other hand, when the interconnect signal ICN is at a logic low state, the gamma line interconnect circuit GIC may operate in a fine restore mode. In this case, the gamma line interconnect circuit GIC may disconnect the first gamma line GML1 to the n-th gamma line GMLn. For example, the gamma line interconnect circuit GIC may release the interconnection between the first gamma line GML1 to the n-th gamma line GMLn and the resistor string RSTR.

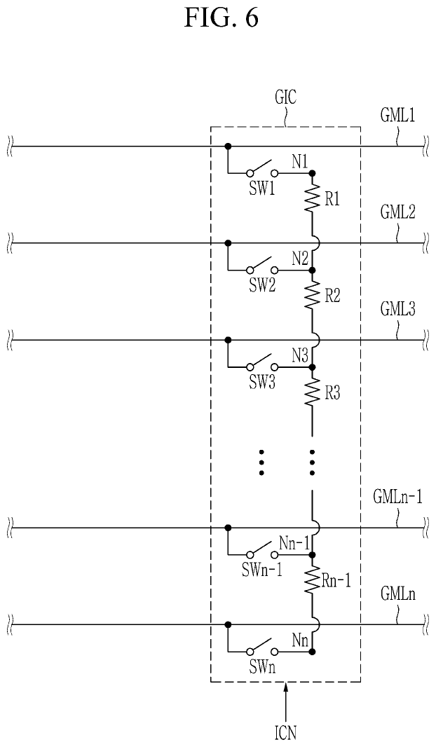

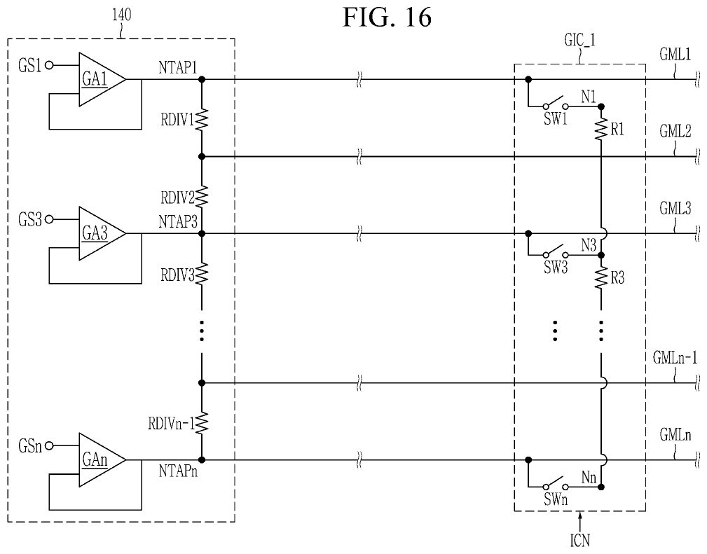

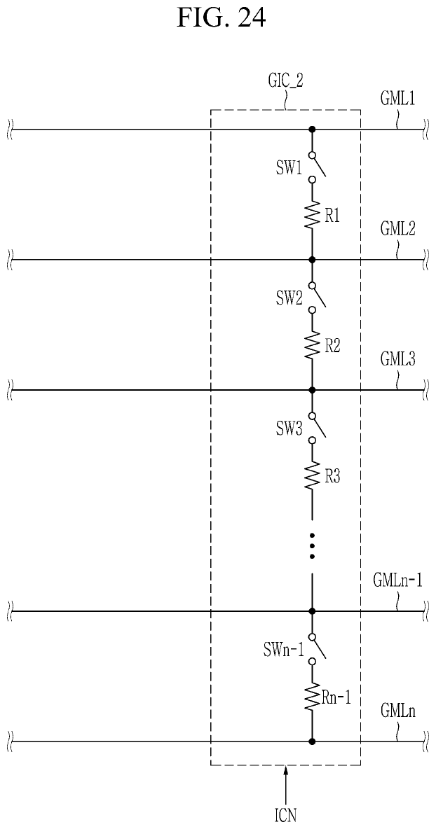

A detailed configuration and operation of the gamma line interconnect circuit GIC will be described in more detail with reference to FIG. 6 to FIG. 8, FIG. 16, and FIG. 24.

In an embodiment, the interconnect signal ICN may be provided from the control logic circuit 110.

FIG. 6 is a circuit diagram of the gamma line interconnect circuit of FIG. 5 according to an embodiment of the present disclosure. Hereinafter, referring to FIG. 6, the gamma line interconnect circuit GIC formed to interconnect the first gamma line GML1 to the n-th gamma line GMLn in response to the interconnect signal ICN will be described.

Referring to FIG. 1 to FIG. 6, the gamma line interconnect circuit GIC may include a first switch SW1 to an n-th switch SWn. One terminals of the first switch SW1 to the n-th switch SWn may be respectively connected with the first gamma line GML1 to the n-th gamma line GMLn. The other terminals of the first switch SW1 to the n-th switch SWn may be respectively connected with a first node N1 to an n-th node Nn. For example, the first switch SW1 may be connected between the first gamma line GML1 and the first node N1, and the n-th switch SWn may be connected between the n-th gamma line GMLn and the n-th node Nn.

The gamma line interconnect circuit GIC may include the resistor string RSTR. The resistor string RSTR may include a first resistor R1 to an (n-1) th resistor Rn-1 connected in series between the first node N1 and the n-th node Nn. In this case, the first to (n-1)-th resistors R1˜Rn-1 may be connected with each other through the second to (n-1)-th nodes N2˜Nn-1. For example, first resistor R1 may be connected between the first node N1 and the second node N2, and the second resistor R2 may be connected between the second node N2 and the third node N3. In a similar way, the (n-1) th resistor Rn-1 may be connected between the (n-1) th node Nn-1 and the n-th node Nn.

The first switch SW1 to the n-th switch SWn may operate in response to the interconnect signal ICN. For example, the first switch SW1 to the n-th switch SWn may be turned on when the interconnect signal ICN is at a logic high state, and may be turned off when the interconnect signal ICN is at a logic low state. That is, the first switch SW1 to the n-th switch SWn may be turned on during the gamma line interconnect circuit GIC operates in the coarse restore mode, and may be turned off during operating in the fine restore mode.

In an embodiment, when the gamma line interconnect circuit GIC operates in the coarse restore mode, a resistance-capacitance (RC) time constant between the source driver 130 and the gamma voltage generator 140 may be reduced by the first resistor R1 to the (n-1) resistor Rn-1 connected between the first gamma line GML1 to the n-th gamma line GMLn.

In an embodiment, when the gamma line interconnect circuit GIC operates in the fine restore mode, because the first gamma line GML1 to the n-th gamma line GMLn are disconnected, thus the voltage levels of the first gamma line GML1 to the n-th gamma line GMLn may be precisely restored to a voltage level of a gamma voltage generated by the gamma voltage generator 140.

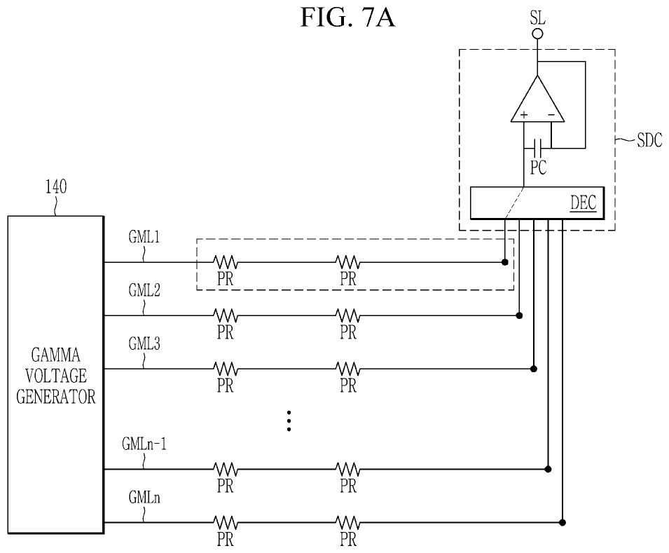

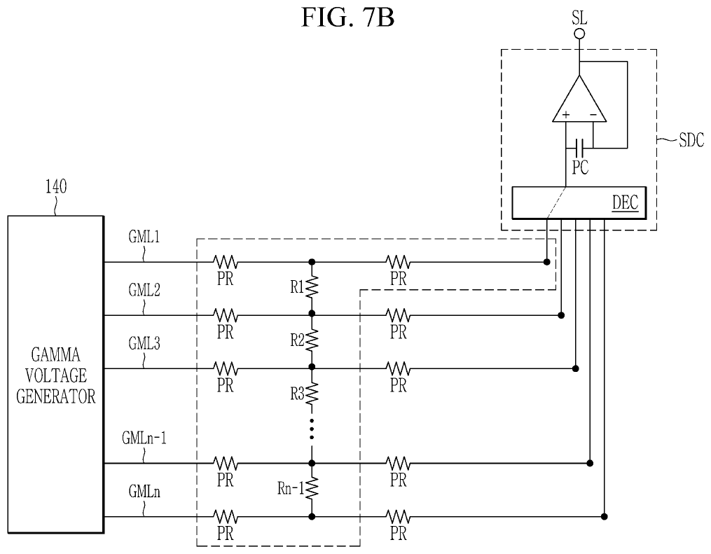

The RC time constant between the source driver 130 and the gamma voltage generator 140 according to the logic level of the interconnect signal ICN will be described in more detail hereinafter with reference to FIG. 7A and FIG. 7B.

In FIG. 6, for a more concise explanation, the configuration of the gamma line interconnect circuit GIC that interconnects the first to n-th gamma lines GML1 to GMLn in response to the interconnect signal ICN has been representatively described. However, the scope of the present disclosure is not limited thereto, and the gamma line interconnect circuit GIC may be implemented to interconnect some of the first to n-th gamma lines GML1 to GMLn. An embodiment of a gamma line interconnect circuit GIC implemented to interconnect some of the first gamma line GML1 to the n-th gamma line GMLn will be described with reference to FIG. 16. However, a function and operation of the gamma line interconnect circuit GIC of FIG. 6 will be representatively described hereinafter.

FIG. 7A and FIG. 7B show equivalent resistance between the source driver and the gamma voltage generator according to an operation mode of the gamma line interconnect circuit. Hereinafter, referring to FIG. 7A, the equivalent resistance between the source drive circuit SDC and the gamma voltage generator 140 when the gamma line interconnect circuit GIC operates in a fine restore mode will be described, and referring to FIG. 7B, the equivalent resistance between the source drive circuit SDC and the gamma voltage generator 140 when the gamma line interconnect circuit GIC operates in a coarse restore mode will be described.

First, referring to FIG. 1 to FIG. 6 and FIG. 7A, when the gamma line interconnect circuit GIC operates in the fine restore mode, the gamma line interconnect circuit GIC may not establish connections between the first gamma line GML1 to the n-th gamma line GMLn. In this case, equivalent resistance between the source drive circuit SDC and the gamma voltage generator 140 may be determined by parasitic resistances PR connected in series (shown by dotted line).

Meanwhile, referring to FIG. 1 to FIG. 6 and FIG. 7B, when the gamma line interconnect circuit GIC operates in the coarse restore mode, the gamma line interconnect circuit GIC may interconnect between the first gamma line GML1 to the n-th gamma line GMLn. That is, the gamma line interconnect circuit GIC may connect between the first gamma line GML1 to the n-th gamma line GMLn through the first resistor R1 to the (n-1) th resistor Rn-1. In this case, the equivalent resistance between the source drive circuit SDC and the gamma voltage generator 140 may be determined by the parasitic resistances PR and the first resistor R1 to the (n-1) th resistor Rn-1 (shown by dotted line).

That is, according to an embodiment of the present disclosure, when the gamma line interconnect circuit GIC operates in the coarse restore mode, the equivalent resistance encountered when current travels from the source drive circuit SDC to the gamma voltage generator 140 may decrease compared to the case that the gamma line interconnect circuit GIC operates in the fine restore mode. Accordingly, when the gamma line interconnect circuit GIC operates in the coarse restore mode, the RC time constant between the source drive circuit SDC and gamma voltage generator 140 may be reduced compared to the case the gamma line interconnect circuit GIC operates in the fine restore mode. In this case, the voltage level swing of the victim gamma line GML_victim due to parasitic capacitance PC of the source drive circuit SDC, which occurs when the gray level of the source drive circuit SDC is changed, can be minimized.

However, the when the gamma line interconnect circuit GIC operates in the coarse restore mode, an error may occur in the voltage levels of the first gamma line GML1 to the n-th gamma line GMLn due to the first resistor R1 to the (n-1) th resistor Rn-1 connected between the first gamma line GML1 to the n-th gamma line GMLn. That is, even after a sufficient time elapses after a change in the gray level of the source drive circuit SDC, the voltage levels of the first gamma line GML1 to the n-th gamma line GMLn may not achieve uniformity or consistency. For example, because a voltage level of an area close to a gamma voltage generator 140 of the first gamma line GML1 will not be the same as that of an area far from the gamma voltage generator 140, even after sufficient time has elapsed after a change in the gray level of the source drive circuit SDC. In this case, since different gamma voltages are provided to different source drive circuits operating at the same gray level, errors may occur in the image output by the display panel DP.

On the other hand, when the gamma line interconnect circuit GIC operates in fine restore mode, the first resistor R1 to the (n-1) th resistor Rn-1 between the first gamma line GML1 to the n-th gamma line GMLn may not be connected. In this case, the voltage level of the first gamma line GML1 to the n-th gamma line GMLn will be able to converge to an intended voltage level after the gray level of the source drive circuit SDC is changed and sufficient time has elapsed. For example, after sufficient time has elapsed after the gray level of the source drive circuit SDC is changed, due to the high input impedance of the source amplifier SA, the voltage level of the first gamma line GML1 becomes uniform regardless of the distance from the gamma voltage generator 140. Therefore, when the gamma line interconnect circuit GIC operates in the fine restore mode, a uniform and consistent gamma voltage can be provided to different source drive circuits.

In an embodiment, the magnitude of the parasitic resistance PR shown in FIG. 7A and FIG. 7B may be the same as or different from each other.

That is, the scope of the present disclosure may not be limited to the magnitude of the parasitic resistance PR.

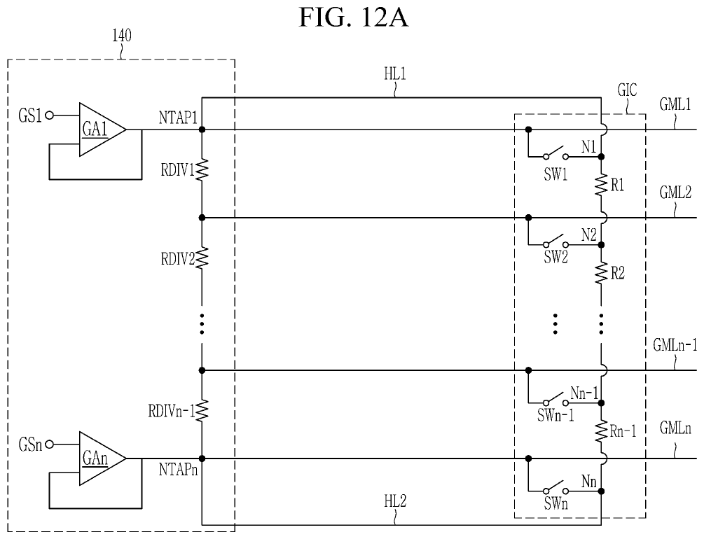

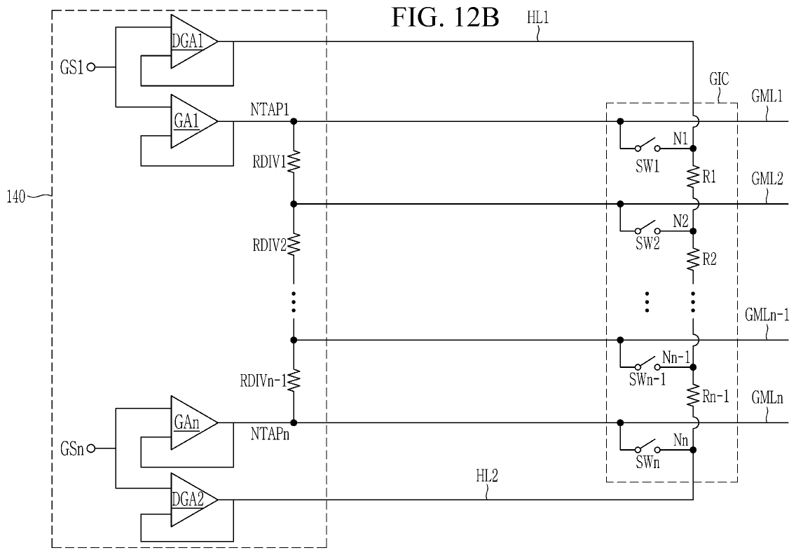

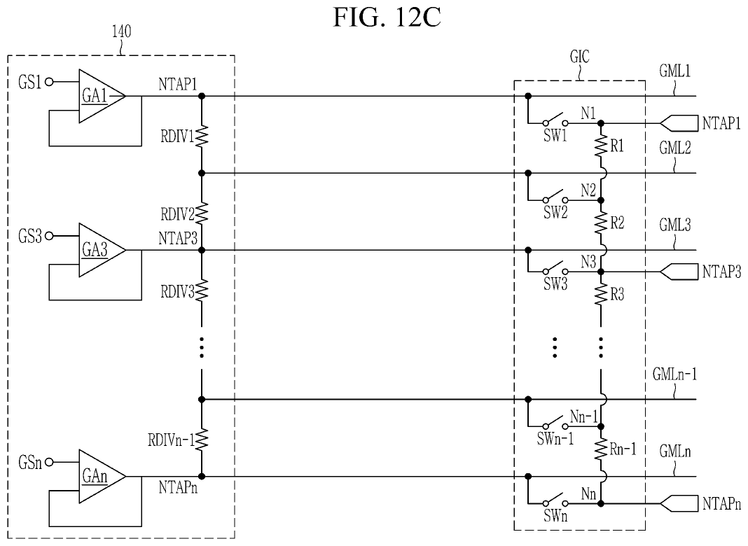

For a more concise explanation, FIG. 7A and FIG. 7B shows only the parasitic resistances PR and the first resistor R1 to the (n-1) th resistor Rn-1, but the scope of the present disclosure is not limited thereto. For example, the magnitude of the equivalent resistance viewed from the source drive circuit SDC in the direction of the gamma voltage generator 140 (i.e., the equivalent resistance encountered when current travels from the source drive circuit SDC to the gamma voltage generator 140) may be determined based on resistances of a divider circuit inside the gamma voltage generator 140. The configuration of the divider circuit will be described with reference to FIG. 12A to 12C.

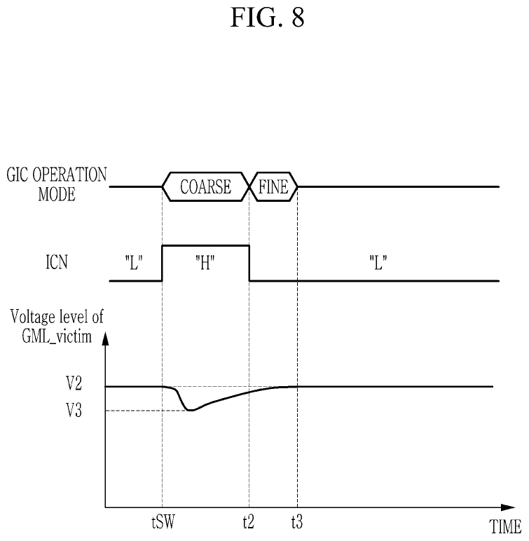

FIG. 8 shows the operation of the gamma line interconnect circuit and a voltage level of the victim gamma line according to an embodiment of the present disclosure. Referring to FIG. 1 to FIG. 8, the interconnect signal ICN may be at a logic low state before the switching time point tSW. In this case, the gamma line interconnect circuit GIC may not interconnect the first gamma line GML1 to the n-th gamma line GMLn and the voltage level of the victim gamma line GML_victim may be constant at “V2” until the switching time point tSW.

The gray level of the source drive circuit SDC may be changed at the switching time point tSW. For example, the gray level of the source drive circuit SDC may be changed to correspond to the victim gamma line GML_victim.

The interconnect signal ICN may transition to a logic high state at the switching time point tSW. In this case, the gamma line interconnect circuit GIC may enter a coarse restore mode COARSE in response to interconnect signal ICN transitioning to the logic high state.

When the gamma line interconnect circuit GIC operates in a coarse restore mode COARSE, the RC time constant between the source drive circuit SDC and gamma voltage generator 140 may decrease. In this case, the voltage level swing of the victim gamma line GML_victim due to the change in the gray level of the source drive circuit SDC can be minimized. For example, after the switching time point tSW, the voltage level of the victim gamma line GML_victim may be reduced to V4 unlike previously described with reference to FIG. 4.

In an embodiment, a voltage difference between V2 and V4 may be less than a voltage difference between V2 and V3. For example, V4 may have a higher voltage than V3. However, the range of present disclosure is not limited thereto.

The interconnect signal ICN may transition to the logic low state at a second time point t2 after the switching time point tSW. In this case, the gamma line interconnect circuit GIC may enter the a fine restore mode FINE in response to the interconnect signal ICN transitioned to the logic low state.

In an embodiment, a time interval between the switching time point tSW and the second time point t2 may be pre-determined. However, the scope of the present disclosure is not limited thereto, and second time point t2 may be determined based on a restored voltage of the victim gamma line GML_victim. For example, the second time point t2 may be determined as a time at which the voltage level of the victim gamma line GML_victim reached a voltage level (e.g., a referential voltage level) corresponding to the predetermined ratio (e.g., 80%) of V2. However, in the following, for a more concise explanation, the second time point t2 will be assumed to refer to a point in time when a pre-determined time period has elapsed since the switching time point tSW.

While the gamma line interconnect circuit GIC operates in fine restore mode FINE, the gamma line interconnect circuit GIC may not interconnect the first gamma line GML1 to the n-th gamma line GMLn. In this case, the voltage level of the victim gamma line GML_victim may be accurately restored to V2.

After a third time point t3, the voltage level of the victim gamma line GML_victim may maintain V2. In this case, the voltage V2 may be uniformly provided to the plurality of source drive circuit SDCs operating at the gray level corresponding to the victim gamma line GML_victim.

In an embodiment, the time interval between the switching time point tSW and the third time point t3 may be less than the time interval between the switching time point tSW and the first time point t1 previously described with reference to FIG. 4. That is, according to an embodiment of present disclosure, since the gamma line interconnect circuit GIC operates in the coarse restore mode COARSE between the switching time point tSW and the second time point t2, the voltage level swing of the victim gamma line GML_victim may be minimized.

In an embodiment, when the voltage level swing of the victim gamma line GML_victim is minimized, the time required for the settling of the output signal of the source drive circuits SDC operating based on the voltage level of the victim gamma line GML_victim is may be minimized. Therefore, according to an embodiment of the present disclosure, the operation speed of the display device DPD can be improved.

In an embodiment, the time interval between the switching time point tSW and the second time point t2 may be greater than the time interval between the second time point t2 and the third time point t3. That is, after the gray level of the source drive circuit SDC is changed, a time period during which the gamma line interconnect circuit GIC operates in the coarse restore mode COARSE may be longer than a time period during which the gamma line interconnect circuit GIC operates in the fine restore mode FINE. More specifically, the ratio of the time interval between the switching time point tSW and the second time point t2 to the time interval between the second time point t2 and the third time point t3 may be about “3:1”. However, the scope of the present disclosure is not limited thereto.

In an embodiment, while the voltage level of the victim gamma line GML_victim maintains the voltage V2, the victim gamma line GML_victim may be referred to as being in a steady state. For example, before the switching time point tSW and after the third time point t3, the victim gamma line GML_victim may be referred to as being in a steady state. However, the scope of the present disclosure is not limited thereto.

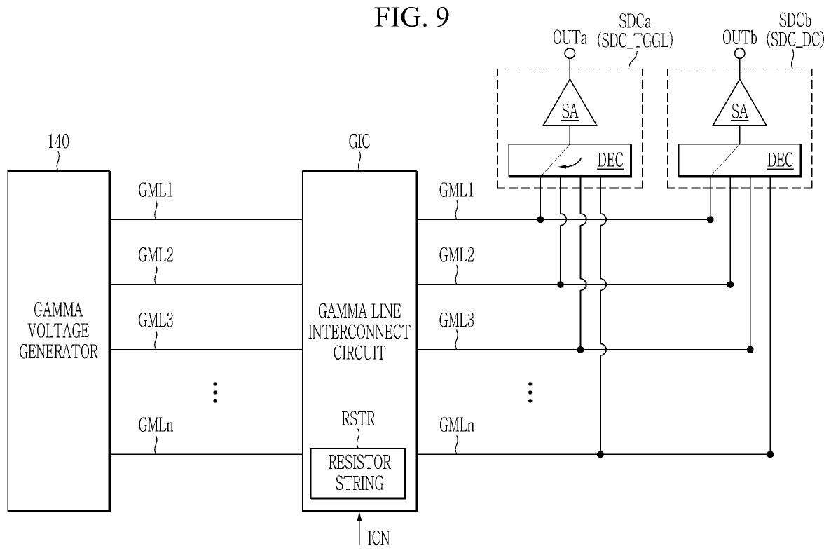

FIG. 9 shows the source drive circuits connected to the gamma lines according to an embodiment of the present disclosure. Referring to FIG. 1 to FIG. 9, the gamma voltage generator 140 may provide different gamma voltages to the first gamma line GML1 to the n-th gamma line GMLn. The first gamma line GML1 to the n-th gamma line GMLn may be connected with a plurality of source drive circuits. The gamma line interconnect circuit GIC may interconnect the first gamma line GML1 to the n-th gamma line GMLn in response to the interconnect signal ICN. The configuration and function of the gamma voltage generator 140, gamma line interconnect circuit GIC are similar to those described above, and therefore detailed descriptions are omitted.

A first source drive circuit SDCa and a second source drive circuit SDCb may be connected with the first gamma line GML1 to the n-th gamma line GMLn. Each of the first source drive circuit SDCa and the second source drive circuit SDCb may be one of the above-described first to m-th source drive circuits SDC1 to SDCm.

A gray level of the first source drive circuit SDCa may be changed in a manner similar to that described above with reference to FIG. 3A and FIG. 3B. For example, the gray level of the first source drive circuit SDCa may be changed to correspond to the first gamma line GML1. In this case, the first source drive circuit SDCa may provide a first output signal OUTa generated based on the voltage level of the first gamma line GML1 to a source line. Hereinafter, for a more concise description, the first source drive circuit SDCa will also be referred to as a source drive circuit SDC_TGGL, and the first output signal OUTa will also be referred to as an output signal OUT_TGGL.

A gray level of the second source drive circuit SDCb may not be changed. For example, the gray level of the second source drive circuit SDCb may maintain to correspond to the first gamma line GML1. In this case, the second source drive circuit SDCb may provide a second output signal OUTb generated based on the voltage level of the first gamma line GML1 to a source. Hereinafter, for a more concise description, the second source drive circuit SDCb will also be referred to as a source drive circuit SDC_DC, and the second output signal OUTb will also be referred to as an output signal OUT_DC.

When the gray level of the first source drive circuit SDCa is changed to correspond to the first gamma line GML1, a swing may occur in the voltage level of the first gamma line GML1. That is, when the first source drive circuit SDCa is changed, the first gamma line GML1 may become the victim gamma line GML_victim. In this case, an error may occur in an output of the second source drive circuit SDCb having a gray level corresponding to the first gamma line GML1.

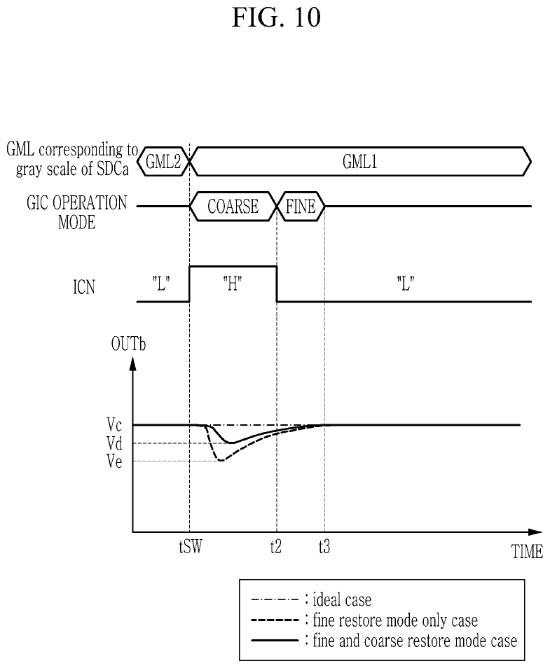

That is, although video data VDT indicates that the second output signal OUTb maintains a constant voltage level, when a swing occurs in the voltage level of the first gamma line GML1, a swing may also occur in the voltage of the second output signal OUTb. Accordingly, when the voltage level swing of the first gamma line GML1 is minimized, the voltage swing of the second output signal OUTb may also be minimized. For example, when the gamma line interconnect circuit GIC operates in a manner similar to that described above with reference to FIG. 5 to FIG. 8, since the swing in the voltage level of the first gamma line GML1 can be minimized, the voltage swing in the second output signal OUTb can also be minimized. The operation of the gamma line interconnect circuit GIC according to the change in the gray level of the first source drive circuit SDCa and the swing of the second output signal OUTb will be described in more detail with reference to FIG. 10.

FIG. 10 shows a voltage level of the second output signal according to the operation of the gamma line interconnect circuit of FIG. 9. Referring to FIG. 1 to FIG. 10, a gray level of the first source drive circuit SDCa may be changed at the switching time point tSW. For example, the gray level of the first source drive circuit SDCa may correspond to the second gamma line GML2 before the switching time point tSW, and the gray level of the first source drive circuit SDCa may correspond to the first gamma line GML1 after the switching time point tSW. In this case, a swing may occur in the voltage level of the first gamma line GML1 after the switching time point tSW.

The interconnect signal ICN may transition to a logic high state at the switching time point tSW. In this case, the gamma line interconnect circuit GIC may enter the coarse restore mode COARSE. The interconnect signal ICN may transition to a logic low state at a second time point t2 after the switching time point tSW. In this case, the gamma line interconnect circuit GIC may enter the fine restore mode FINE. A method of determining the second time point t2 and the operation of each operation mode of the gamma line interconnect circuit GIC are similar to those described above with reference to FIG. 8, and therefore, a detailed description is omitted.

The graph shown as a one dash-one dot line shows the voltage level of the second output signal OUTb in the ideal case (e.g., when there is no parasitic capacitance PC in the source drive circuits). In this case, the voltage level of the second output signal OUTb may be maintained at the voltage Vc regardless of the change in the gray level of the first source drive circuit SDCa. That is, in the following, for more concise description, it is assumed that the video data VDT indicates that the second output signal OUTb will maintain a constant voltage level. However, the scope of the present disclosure is not limited thereto.

A dotted-line graph shows the voltage level of the second output signal OUTb when the gamma line interconnect circuit GIC operates only in fine restore mode FINE. That is, the dotted-line graph shows the voltage level of the second output signal OUTb when the gamma line interconnect circuit GIC does not interconnect the first gamma line GML1 to the n-th gamma line GMLn regardless of the gray level change of the first source drive circuit SDCa. In this case, the voltage level of the second output signal OUTb may be decreased to the voltage Ve, and may be restored to the voltage Vc after the third time point t3.

The solid-line graph shows the voltage level of the second output signal OUTb when the gamma line interconnect circuit GIC operates in the coarse restore mode COARSE from the switching time point tSW to the second time point t2, according to an embodiment of the present disclosure. In this case, the voltage level of the second output signal OUTb may decrease to the voltage Vd and may be restored to the voltage Vc at a third time point t3.

In an embodiment, a voltage difference between Vc and Vd may be less than a voltage difference between Vc and Ve. For example, Vd may be a higher voltage than Ve. However, the scope of the present disclosure is not limited thereto.

That is, the size and duration of the swing of the second output signal OUTb, caused by the voltage swing of the victim gamma line GML_victim (e.g., first gamma line GML1) due to the gray level change of the first source drive circuit SDCa, can be minimized. In this case, errors observed by the user of the display device DPD can be minimized.

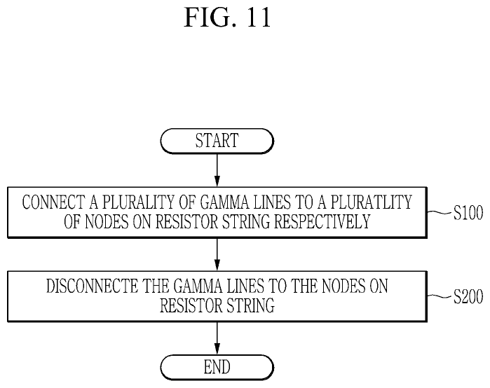

FIG. 11 shows an operation method of the gamma line interconnect circuit of FIG. 1. Referring to FIG. 1 to FIG. 10, in operation S100, the gamma line interconnect circuit GIC may respectively connect the plurality of gamma lines to the plurality of nodes of the resistor string RSTR. For example, the gamma line interconnect circuit GIC may turn on switches between the resistor RSTR and the gamma lines when a gray level of one of the source drive circuits is changed. In this case, the RC time constant between the source driver 130 and the gamma voltage generator 140 is minimized, and therefore the voltage level of the victim gamma line GML_victim can be quickly restored.

In operation S200, the gamma line interconnect circuit GIC may release the interconnection between the plurality of nodes of the resistor string RSTR and the plurality of gamma lines. For example, the gamma line interconnect circuit GIC may turn off switches between the resistor string RSTR and the gamma lines after step S100 is performed and a predetermined time elapses. In this case, since the resistance is not connected between the plurality of gamma lines, the voltage level of the victim gamma line GML_victim may be restored to an accurate level.

FIG. 12A to FIG. 12C respectively show configurations of a gamma line interconnect circuit implemented according to an embodiment.

First, referring to FIG. 1 to FIG. 8 and FIG. 12A, a gamma voltage generator 140 may include a plurality of gamma amplifiers (GA) and a divider circuit. In this case, the number of gamma amplifiers GA included in the gamma voltage generator 140 may be less than the number of gamma lines (i.e., “n”).

The plurality of gamma amplifiers GA may be connected to different gamma lines through different tap nodes. Hereinafter, for a more concise description, it is assumed that a k-th gamma amplifier GAk is connected with a k-th gamma line GMLk through a k-th tap node NTAPK. For example, the first gamma amplifier GA1 may be connected with the first gamma line GML1 through the first tap node NTAP1, and the n-th gamma amplifier GAn may be connected with the n-th gamma line GMLn through the n-th tap node NTAPn.

The first gamma amplifier GA1 may receive a first gamma seed voltage GS1 through a first input terminal. A second input terminal and an output terminal of the first gamma amplifier GA1 may be connected with the first tap node NTAP1. In this case, the first gamma amplifier GA1 may provide a gamma voltage corresponding to the first gamma seed voltage GS1 to the first tap node NTAP1. Similarly, the n-th gamma amplifier GAn may provide a voltage corresponding to an n-th gamma seed voltage GSn to an n-th tap node NTAPn.

For a more concise description, hereinafter, a node directly connected to a gamma amplifier and a gamma line will be referred to as a tap node, and a gamma line connected through a gamma amplifier and a tap node will be referred to as a tap line. However, the scope of the present disclosure is not limited thereto.

The divider circuit may include a first division resistor RDIV1 to a (n-1) th division resistor RDIVn-1. The first division resistor seventh time point t7 to the (n-1) th division resistor RDIVn-1 may be connected in series between the first tap node NTAP1 and the n-th tap node NTAPn. In this case, a second gamma line GML2 to a (n-1) th gamma line GMLn-1 may be respectively connected to nodes between the first division resistor seventh time point t7 to the (n-1) th division resistor RDIVn-1. For example, the second gamma line GML2 may be connected to a node between the first division resistor RDIV1 and the second division resistor RDIV2.

The gamma line interconnect circuit GIC may be connected with the first tap node NTAP1 through a first hold line HL1. For example, the first node N1 may be connected with the first tap node NTAP1 through the first hold line HL1. In this case, the first node N1 and the first tap node NTAP1 may be connected in parallel through the first gamma line GML1 and the first hold line HL1.

The gamma line interconnect circuit GIC may be connected with the n-th tap node NTAPn through a second hold line HL2. For example, the n-th node Nn may be connected with the n-th tap node NTAPn through the second hold line HL2. In this case, the n-th node Nn and the n-th tap node NTAPn may be connected in parallel through the n-th gamma line GMLn and the second hold line HL2.

That is, according to the embodiment of FIG. 12A, the resistor string RSTR may be connected with the first tap node NTAP1 and the n-th tap node NTAPn. In this way, the resistor string RSTR may receive first hold voltage through the first hold line HL1 and second hold voltage through the second hold line HL2. In this case, the resistor string RSTR may not be floated even through a first switch SW1 of the gamma line interconnect circuit GIC is turned off. Thus, a voltage level swing of the first gamma line GML1 to the n-th gamma line GMLn that may occur when the first switch SW1 to the n-th switch SWn are turned on again can be minimized.

Next, referring to FIG. 1 to FIG. 8 and FIG. 12B, the gamma voltage generator 140 may further include a first dummy gamma amplifier DGA1 and a second dummy gamma amplifier DGA2.

The first dummy gamma amplifier DGA1 may generate a voltage corresponding to the first gamma amplifier GA1. For example, a first input terminal of the first dummy gamma amplifier DGA1 may receive a first gamma seed voltage GS1. A second input terminal of the first dummy gamma amplifier DGA1 may be connected with an output terminal of the first dummy gamma amplifier DGA1. The output terminal of the first dummy gamma amplifier DGA1 may be connected with the first node N1 through the first hold line HL1.

Similarly, the second dummy gamma amplifier DGA2 may generate a voltage corresponding to the n-th gamma amplifier GAn. For example, a first input terminal of the second dummy gamma amplifier DGA2 may receive the n-th gamma seed voltage GSn. A second input terminal of the second dummy gamma amplifier DGA2 may be an output terminal of the second dummy gamma amplifier DGA2. The output terminal of the second dummy gamma amplifier DGA2 may be connected with the n-th node Nn through the second hold line HL2.

That is, according to an embodiment of FIG. 12B, although the first switch SW1 to the n-th switch SWn of the gamma line interconnect circuit GIC are turned off, the resistor string RSTR may not be floated. Therefore, a voltage level swing of the first gamma line GML1 to the n-th gamma line GMLn that may occur when the first switch SW1 to the n-th switch SWn are turned on again can be minimized.

Next, referring to FIG. 1 to FIG. 8 and FIG. 12C, the resistor string RSTR may be connected with tap nodes.

For example, nodes connected with tap lines through switches in the resistor string RSTR may be connected with corresponding tap nodes. For example, the first node N1 connected with the first gamma line GML1 through the first switch SW1 may be connected with the first gamma line GML1 through the first tap node NTAP1. Similarly, the third node N3 connected with the third gamma line GML3 through the third switch SW3 may be connected with a third tap node NTAP3 connected with the third gamma line GML3, and the n-th node Nn connected with the n-th gamma line GMLn through the n-th switch SWn may be connected with the n-th tap node NTAPn connected with the n-th gamma line GMLn.

That is, according to an embodiment of FIG. 12C, the respective nodes of the resistor string RSTR may be connected with different tap nodes. Although the first switch SW1 to the n-th switch SWn are turned off, the voltage level of the resistor string RSTR can be determined based on the gamma voltage, and thus the voltage level swing of the first gamma line GML1 to the n-th gamma line GMLn, which may occur when the first switch SW1 to the n-th switch SWn are turned on again can be minimized.

For a more concise description, in FIG. 12C, although an embodiment in which the third gamma line GML3 is a tap line has been described, the range of present disclosure is not limited thereto. That is, any gamma lines among the first gamma line GML1 to the n-th gamma line GMLn may be implemented as a tap line.

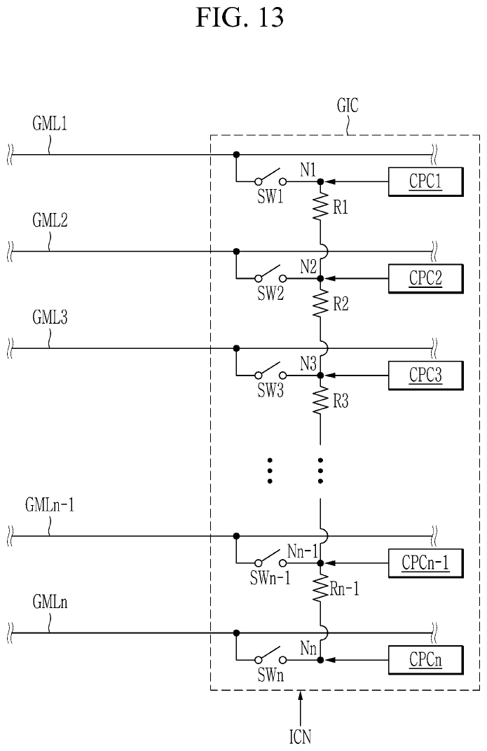

FIG. 13 shows a configuration of the gamma line interconnect circuit implemented according to an embodiment. Referring to FIG. 1 to FIG. 8 and FIG. 13, the nodes included in the resistor string RSTR of the gamma line interconnect circuit GIC may be respectively connected with current provide circuits CPC. For example, the first node N1 to the n-th node Nn may be respectively connected with a first current provide circuit CPC1 to an n-th current provide circuit CPCn.

Each of the first current provide circuit CPC1 to the n-th current provide circuit CPCn may provide a current to a connected node while the gamma line interconnect circuit GIC operates in the coarse restore mode COARSE. In this case, the current can be provided to the first gamma line GML1 to the n-th gamma line GMLn through the resistor string RSTR, and thus the voltage level of the victim gamma line GML_victim may be more quickly restored.

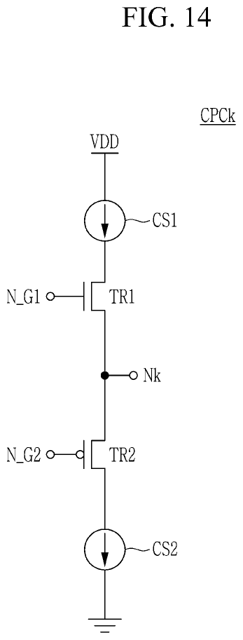

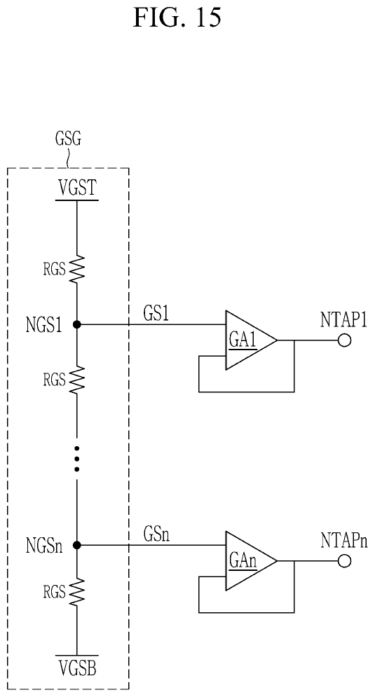

In an embodiment, due to the change in the gray level of the source drive circuit, the size of the voltage level swing that may occur in the first gamma line GML1 to the n-th gamma line GMLn may vary. For example, among the first gamma line GML1 to the n-th gamma line GMLn, the size of the voltage level swing occurring in the tap line may be less than the size of the voltage level swing occurring in the gamma line other than the tap line. Accordingly, each of the first current provide circuit CPC1 to the n-th current provide circuit CPCn may be implemented to provide a current of optimized intensity to the connected node according to the voltage level swing size of the corresponding gamma line. In this case, the dispersion of voltage level swings occurring in different gamma lines can be minimized. A more detailed configuration of the current provide circuit will be described with reference to FIG. 14 and FIG. 15.

FIG. 14 is a circuit diagram that shows the current provide circuit of FIG. 13. Referring to FIG. 1 to FIG. 8, FIG. 13, and FIG. 14, the first current provide circuit CPC1 to the n-th current provide circuit CPCn may be respectively implemented as push-and-pull current sources. Hereinafter, for a more concise description, a configuration of a k-th current providing circuit CPCk among the first current provide circuit CPC1 to the n-th current provide circuit CPCn will be described as a representative example. However, the scope of the present disclosure is not limited thereto, and each of the first current provide circuit CPC1 to the n-th current provide circuit CPCn may be implemented in a similar manner.

The k-th current providing circuit CPCk may include a first transistor TR1, a second transistor TR2, a first current source CS1, and a second current source CS2. The first current source CS1 may be connected between a drain terminal of the first transistor TR1 and a power voltage VDD. The second current source CS2 may be connected between a drain terminal of the second transistor TR2 and a ground voltage.

Source terminals of the first transistor TR1 and second transistor TR2 may be connected with a k-th node Nk. In this case, the current provide circuit CPC may provide the current to the k-th node Nk based on a voltage provided to a gate terminal N_G1 (hereinafter referred to as a first gate terminal) of the first transistor TR1 and a voltage provided to a gate terminal N_G2 (hereinafter referred to as a second gate terminal) of the second transistor TR2.

In an embodiment, the current provide circuit CPC may be configured to operate only during periods when the interconnect signal ICN is at a logic high state. That is, the current provide circuit CPC may be configured to provide a current to the k-th node Nk only while the gamma line interconnect circuit GIC operates in the coarse restore mode COARSE. For example, switches may be further connected between source terminals of the first transistor TR1 and the second transistor TR2 and the k-th node Nk. However, the scope of the present disclosure is not limited thereto, and it may be configured such that the first and second current sources CS1 and CS2 operate only during a period in which the interconnect signal ICN is at the logic high state. That is, the scope of the present disclosure is not limited to the specific implementation method of the current provide circuit CPC.

In an embodiment, the first gate terminal N_G1 and the second gate terminal N_G2 may receive the same voltage. For example, the first gate terminal N_G1 and the second gate terminal N_G2 may be implemented to receive one (e.g., a k-th gamma seed voltage GSk) among the plurality of gamma seed voltages. However, the scope of the present disclosure is not limited thereto, and the first gate terminal N_G1 and the second gate terminal N_G2 may be implemented to receive any tap voltage.

In an embodiment, the voltage received by the first gate terminal N_G1 and the voltage received by the second gate terminal N_G2 may differ for each of the first current provide circuit CPC1 to the n-th current provide circuit CPCn. For example, a voltage provided to the first gate terminal N_G1 and the second gate terminal N_G2 of the first current provide circuit CPC1 may be a first gamma seed voltage GS1, and a voltage provided to the first gate terminal N_G1 and the second gate terminal N_G2 of the n-th current provide circuit CPCn may be an n-th gamma seed voltage GSn. However, the scope of the present disclosure is not limited thereto.

In an embodiment, the first gate terminal N_G1 and the second gate terminal N_G2 may be implemented to receive different voltages. For example, the first gate terminal N_G1 and the second gate terminal N_G2 may be implemented to receive different gamma seed voltages. An embodiment in which the first gate terminal N_G1 and the second gate terminal N_G2 receive different voltages will be described in more detail with reference to FIG. 15.

FIG. 15 exemplarily illustrates a partial configuration of the gamma voltage generator of FIG. 1. Referring to FIG. 1 to FIG. 8, FIG. 12A to FIG. 12C, and FIG. 13 to FIG. 15, the gamma voltage generator 140 may include a gamma seed voltage generator GSG and plurality of gamma amplifiers GA. The configuration and operation of the plurality of gamma amplifiers GA are similar to those described previously with reference to FIG. 12A to FIG. 12C, and therefore the detailed description is omitted.

The gamma seed voltage generator GSG may include a plurality of gamma seed resistors RGS. The plurality of gamma seed resistors RGS may be connected in series between a gamma seed top voltage VGST and a gamma seed bottom voltage VGSB.

In an embodiment, the gamma seed top voltage VGST may be a power voltage and the gamma seed bottom voltage VGSB may be a ground voltage. However, the scope of the present disclosure is not limited thereto.

In an embodiment, the plurality of gamma seed resistors RGS may have the same size as each other. However, the scope of the present disclosure is not limited thereto, and the plurality of gamma seed resistors RGS may have different sizes.

The plurality of gamma amplifiers GA may be connected to different nodes between the plurality of gamma seed resistors RGS. For example, the first gamma amplifier GA1 may be connected to a first gamma seed node NGS1. In this case, the first gamma amplifier GA1 may be provided with a first gamma seed voltage GS1 from the first gamma seed node NGS1. Similarly, the n-th gamma amplifier Gan may be provided with an n-th gamma seed voltage GSn from an n-th gamma seed node NGSn.

A first gate terminal N_G1 and a second gate terminal N_G2 of the k-th current providing circuit CPCk may be connected to different nodes of the gamma seed voltage generator GSG. That is, the first gate terminal N_G1 and the second gate terminal N_G2 may be implemented to receive different gamma seed voltages. In this case, the voltage provided to the first gate terminal N_G1 may be a sufficiently high voltage to turn on the first transistor TR1. Similarly, the voltage supplied to the second gate terminal N_G2 may be a voltage high enough to turn on the second transistor TR2.

In an embodiment, a gamma seed node connected with the first gate terminal N_G1 and the second gate terminal N_G2 of the k-th current provide circuit CPCk may be determined based on the size of the voltage level swing occurring in the k-th gamma line GMLk. In this case, while the gamma line interconnect circuit GIC operates in the coarse restore mode, a current of optimized intensity may be provided to each gamma line, and thus the distribution of voltage level swings occurring in different gamma lines can be minimized.

For a more concise description, in FIG. 15, an embodiment in which the gamma seed voltage generator GSG generates a plurality of gamma seed voltages GS1 to GSn through a plurality of resistors is representatively described, but the range of present disclosure is not limited thereto. For example, the plurality of gamma seed voltages GS1 to GSn may be provided from the outside of the gamma voltage generator 140. In this case, the first gate terminal N_G1 and the second gate terminal N_G2 of the k-th current providing circuit CPCk may be implemented to externally receive different gamma seed voltages.

FIG. 16 is a circuit diagram that shows a configuration of the gamma line interconnect circuit FIG. 5 according to another embodiment of the present disclosure. Referring to FIG. 1 to FIG. 5 and FIG. 7, a gamma line interconnect circuit GIC_1 may be implemented to interconnect some of a first gamma line GML1 to an n-th gamma line GMLn in response to an interconnect signal ICN.

A gamma voltage generator 140 may include a plurality of gamma amplifiers GA1, GA2, . . . , GAn and a divider circuit including resistors RDIV1, RDIV2, RDIV3, . . . . RDIVn-1. A detailed configuration of the gamma voltage generator 140 is similar to that described with reference to FIG. 12A or FIG. 12C, and therefore a detailed description is omitted.

The gamma line interconnect circuit GIC_1 may include a plurality of switches respectively connected to a plurality of tap lines. For example, the gamma line interconnect circuit GIC_1 may include a first switch connected with a first gamma line GML1, a third switch connected with a third gamma line GML3, and an n-th switch SWn connected with an n-th gamma line GMLn.

One terminals of the plurality of switches which are not connected to gamma line may be connected to a resistor string RSTR. For example, one terminal of a switch SWk which is not connected to a gamma line, may be connected to the k-th node Nk. That is, the first switch SW1 is connected between the first gamma line GML1 and the first node N1, and the third switch SW3 may be connected between the third gamma line GML3 and the third node N3.

The resistor string RSTR may include a plurality of resistors R1, R3, . . . . Rn. Each of the plurality of resistors may be connected between the plurality of switches connected with tap lines. For example, a first resistor R1 may be connected between a first node N1 and a third node N3.

Switches of the gamma line interconnect circuit GIC_1 may operate in response to an interconnect signal ICN. For example, the first, third, and n-th switches SW1, SW3, and SWn may be turned on when the interconnect signal ICN is at a logic high state, and may be turned off when the interconnect signal ICN is at a logic low state. That is, the first, third, and n-th switches SW1, SW3, and SWn may be turned on while the gamma line interconnect circuit GIC_1 operates in a coarse restore mode and may be turned off while operating in a fine restore mode.

That is, according to an embodiment of the present disclosure, the gamma line interconnect circuit GIC_1 may be implemented to interconnect a plurality of tap lines in response to an interconnect signal ICN. However, the scope of the present disclosure is not limited to the number and type of gamma lines interconnected by the gamma line interconnect circuit. For example, the gamma line interconnect circuit may be implemented to interconnect odd numbered gamma lines among a plurality of gamma lines, or to interconnect even numbered gamma lines among a plurality of gamma lines, among a plurality of gamma lines. That is, it may be implemented to interconnect arbitrary gamma lines.

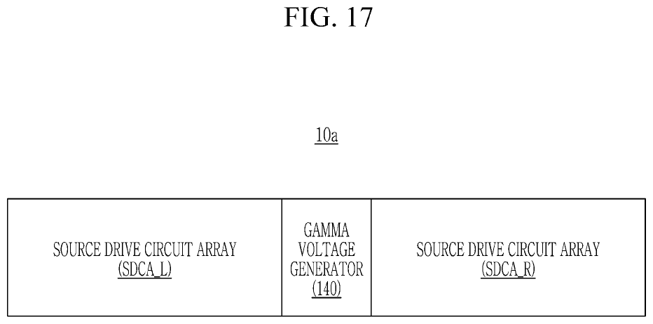

FIG. 17 shows a dispose layout of the display drive circuit according to an embodiment. Hereinafter, referring to FIG. 1 and FIG. 17, a dispose layout of a display drive circuit 10a implemented in a 1-gamma block structure will be described.

A gamma voltage generator 140 may be disposed in a center of the display drive circuit 10a. On both sides of the gamma voltage generator 140, a source drive circuit array SDCA_L and a source drive circuit array SDCA_R may be disposed.

Each of the source drive circuit arrays SDCA_L and SDCA_R may include a plurality of source drive circuits. The plurality of source drive circuits may be respectively connected with the gamma voltage generator 140 through a plurality of gamma lines. In this case, when a gray level of a source drive circuit that is far away from the gamma voltage generator 140 is changed, similar to the description of FIG. 4, a relatively large voltage level swing may occur in a victim gamma line GML_victim.

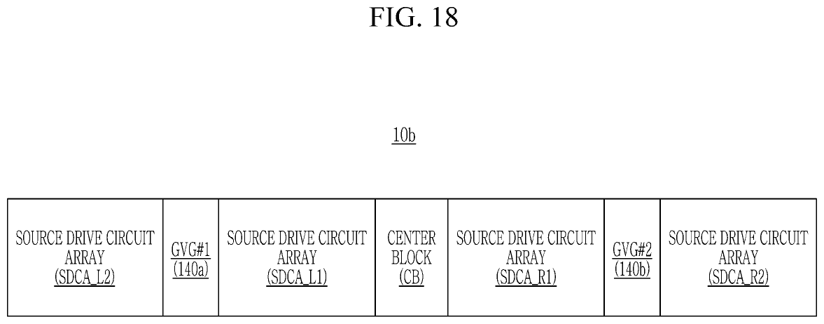

FIG. 18 shows a dispose layout of a display drive circuit according to an embodiment. Hereinafter, a dispose layout of a display drive circuit 10b implemented in a 2-gamma block structure will be described with reference to FIG. 1, FIG. 17, and FIG. 18.

A center block CB may be disposed at a center of a display drive circuit 10b. The center block CB may include a control logic circuit 110. However, the scope of the present disclosure is not limited to a type of a constituent element of the display drive circuit 10b.

A first gamma voltage generator 140a (GVG #1) may be disposed on the left side of the center block CB. A second gamma voltage generator 140b (GVG #2) may be disposed on the right side of the center block CB.

A source drive circuit array SDCA_L2 may be disposed to the left of the first gamma voltage generator 140a, and a source drive circuit array SDCA_L1 may be disposed to the right of the first gamma voltage generator 140a. Each of the source drive circuit arrays SDCA_L1 and SDCA_L2 may include a plurality of source drive circuits. Each of the source drive circuits included in the source drive circuit arrays SDCA_L1 and SDCA_L2 may be connected to the first gamma voltage generator 140a through a plurality of gamma lines.

The source drive circuit array SDCA_R1 may be disposed on the left side of the second gamma voltage generator 140b, and the source drive circuit array SDCA_R2 may be disposed on the right side of the second gamma voltage generator 140b. Each of the source drive circuit arrays SDCA_R1 and SDCA_R2 may include a plurality of source drive circuits. Each of the source drive circuits included in the source drive circuit arrays SDCA_R1 and SDCA_R2 may be connected to the second gamma voltage generator 140b through a plurality of gamma lines.

Therefore, when the number of source drive circuits included in display drive circuit 10a and the number of source drive circuits included in display drive circuit 10b are the same, the average distance between the source drive circuit and the voltage drive circuit of display drive circuit 10b is shorter than that of the drive circuit 10a. For example, a distance between the first gamma voltage generator 140a of the display drive circuit 10b and the farthest source drive circuit may be about half of a distance between the farthest source drive circuit and the gamma voltage generator 140 of the display drive circuit 10a. In this case, since the size of the parasitic resistance between the source drive circuit and the voltage drive circuit of the display drive circuit 10b is reduced, the voltage level swing occurring in the victim gamma line can be reduced.

However, according to an embodiment of FIG. 18, the display drive circuit 10b may include a first gamma voltage generator 140a and a second gamma voltage generator 140b. That is, the display drive circuit 10b may include more gamma voltage generators than the display drive circuit 10a. Therefore, the area and power consumption of the display drive circuit 10b will be greater than those of the display drive circuit 10a.

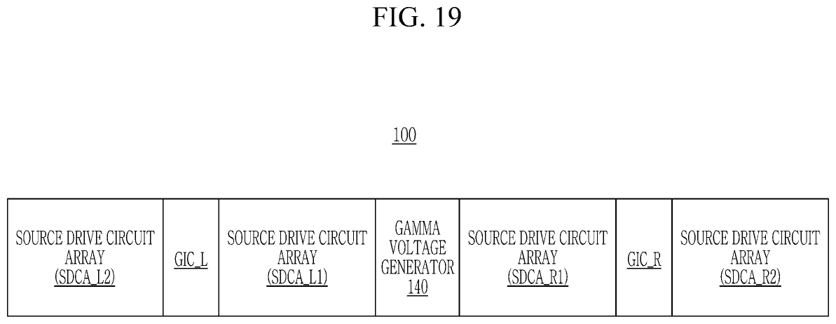

FIG. 19 shows a dispose layout of the display drive circuit according to an embodiment of the present disclosure. Hereinafter, a dispose layout of a display drive circuit 100 implemented in a 1-gamma block with 2-GIC structure will be described with reference to FIG. 19. Referring to FIG. 1 to FIG. 8 and FIG. 17, a gamma voltage generator 140 may be disposed at a center of the display drive circuit 100.

A source drive circuit array SDCA_L1 and a source drive circuit array SDCA_L2 may be disposed on the left side of the gamma voltage generator 140. A source drive circuit array SDCA_R1 and a source drive circuit array SDCA_R2 may be disposed on the right side of the gamma voltage generator 140.

The source drive circuit array SDCA_L1 and the source drive circuit array SDCA_R1 may be disposed adjacent to the gamma voltage generator 140. The source drive circuit array SDCA_L2 and the source drive circuit array SDCA_R2 may be disposed at a distance from the gamma voltage generator 140.

Each of the source drive circuit arrays SDCA_L1, SDCA_L2, SDCA_R1, and SDCA_R2 may include one or more of a first source drive circuit SDC1 to an m-th source drive circuit SDCm.

The gamma voltage generator 140 may be connected with the source drive circuit arrays SDCA_L1, SDCA_L2, SDCA_R1, and SDCA_R2 through a first gamma line GML1 to an n-th gamma line GMLn. In this case, the first gamma line GML1 to the n-th gamma line GMLn may be implemented in a form extending from the gamma voltage generator 140 to the left and right. However, the scope of the present disclosure is not limited thereto.

A gamma line interconnect circuit GIC_L may be disposed between the source drive circuit array SDCA_L1 and the source drive circuit array SDCA_L2. For example, the gamma line interconnect circuit GIC_L may be disposed between an area connected with the source drive circuit arrays SDCA_L1 of the first gamma line GML1 to the n-th gamma line GMLn and an area connected with the source drive circuit arrays SDCA_L2 of the first gamma line GML1 to the n-th gamma line GMLn.

A gamma line interconnect circuit GIC_R may be disposed between the source drive circuit array SDCA_R1 and the source drive circuit array SDCA_R2. For example, the gamma line interconnect circuit GIC_R may be disposed between an area connected with the source drive circuit arrays SDCA_R1 of the first gamma line GML1 to the n-th gamma line GMLn and an area connected to the source drive circuit arrays SDCA_R2 of the first gamma line GML1 to the n-th gamma line GMLn.

The gamma line interconnect circuit GIC_L and the gamma line interconnect circuit GIC_R may interconnect the first gamma line GML1 to the n-th gamma line GMLn when one or more gray levels of the first source drive circuit SDC1 to the m-th source drive circuit are changed. In this case, a voltage level swing of a victim gamma line GML_victim, which is determined by the size of the parasitic resistance between the source drive circuit and the voltage drive circuit, can be minimized. Therefore, when the display drive circuit 100 is implemented with the 1-gamma block 2-GIC structure, the voltage level swing of the victim gamma line GML_victim may be small, compared to the case when the display drive circuit 10a is implemented with the 1-gamma block structure. The detailed configuration and operation of the gamma line interconnect circuit GIC_L and the gamma line interconnect circuit GIC_R have been described with reference to FIG. 1 to FIG. 15, and therefore, a detailed description will be omitted.

Meanwhile, the gamma line interconnect circuit GIC_L and the gamma line interconnect circuit GIC_R may be implemented with a smaller number of circuits than the gamma voltage generator. That is, the gamma line interconnect circuit GIC_L and the gamma line interconnect circuit GIC_R may be implemented with a smaller area than the gamma voltage generator and can be implemented to consume less power. Therefore, compared to the display drive circuit 10b implemented with the 2-gamma block structure, the area and power consumption of the display drive circuit 100 with the 1-gamma block 2-GIC structure may be small.

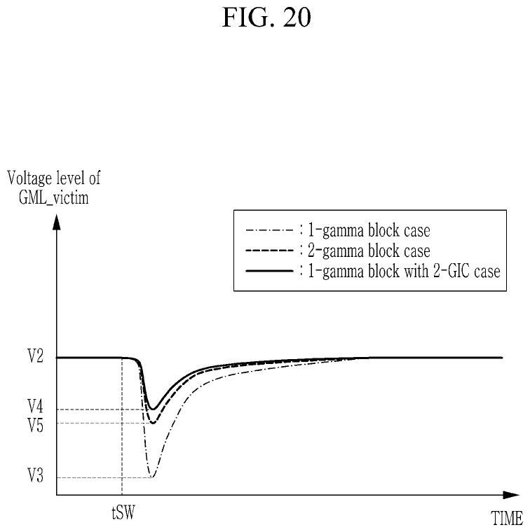

FIG. 20 shows a voltage level swing of a victim gamma line according to the layout described with reference to FIG. 17 to FIG. 19. Referring to FIG. 1 to FIG. 10 and FIG. 17 to FIG. 20, in FIG. 20, the horizontal axis denotes time and the vertical axis denotes a voltage level of the victim gamma line GML_victim in the case that a gray level of a random source drive circuit is changed. Hereinafter, the source drive circuit with the changed gray level is assumed to be the source drive circuit that is most distantly disposed from the gamma voltage generator 140, but the scope of the present disclosure is not limited thereto.

The a single-dot chain graph shows a voltage level of the victim gamma line GML_victim of the display drive circuit 10a implemented in the 1-gamma block structure. That is, when the display drive circuit 10a is implemented in the 1-gamma block structure, the voltage level of the victim gamma line GML_victim after the switching time point tSW may be decreased to V3 as previously described with reference to FIG. 4.

The dotted-line graph shows a voltage level of the victim gamma line GML_victim of the display drive circuit 10b implemented in the 2-gamma block structure. That is, when the display drive circuit 10b is implemented in the 2-gamma block structure, the voltage level of the victim gamma line GML_victim after the switching time point tSW may decrease to V5.

As described with reference to FIG. 1 to FIG. 15 and FIG. 19, the solid-line graph shows the voltage level of the victim gamma line GML_victim when the display drive circuit 100 is implemented in the 1-gamma block 2-GIC structure. That is, when the display drive circuit 100 is implemented with the 1-gamma block 2-GIC structure, the voltage level of the victim gamma line GML_victim after the switching time point tSW may be decreased to V4, which has been previously described with reference to FIG. 8.

In an embodiment, a voltage difference between V2 and V4 may be less than a voltage difference between V2 and V5. A voltage difference between V2 and V5 may be less than a voltage difference between V2 and V3. For example, V4 may be a higher voltage than V5, and V5 may be a higher voltage than V3. However, the scope of the present disclosure is not limited thereto.

That is, according to the embodiment of the present disclosure, the voltage level swing of the victim gamma line GML_victim can be minimized while minimizing the area of the display drive circuit 100. For example, when the display drive circuit is implemented in the 1-gamma block 2-GIC structure according to an embodiment of the present disclosure, similar to the case that the display drive circuit is implemented in the 2-gamma block structure, the voltage level swing of the victim gamma line GML_victim can be minimized (i.e., the voltage level swing of the victim gamma line GML_victim is reduced compared to the case of implementing in the 1-gamma structure) while minimizing the area of the display drive circuit and power consumption (i.e., the area of the display drive circuit and power consumption are reduced compared to the case of implementing in the 2-gamma block structure).

For a more concise description, in FIG. 20, a voltage level of the victim gamma line GML_victim when a gray level of a source drive circuit display mostly distantly from the gamma voltage generator 140 is representatively described, but the scope of the present disclosure is not limited thereto. For example, the second voltage V2 to the fifth voltage V5 may vary depending on whether a gray level of a source drive circuit is changed, the size of resistors included in the gamma line interconnect circuit GIC, and the like.

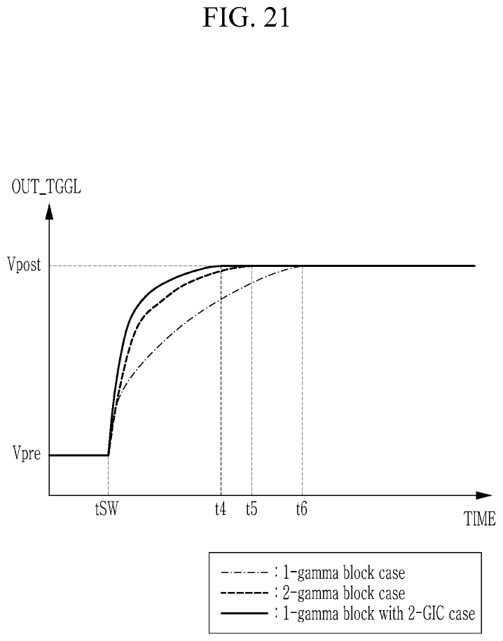

FIG. 21 shows a graph of an output signal of the source drive circuit of which a gray level is changed according to the layout described with reference to FIG. 17 to FIG. 19. Referring to FIG. 1 to FIG. 10 and FIG. 17 to FIG. 21, it is assumed that a gray level of a source drive circuit SDC_TGGL is charged at the switching time point tSW. In FIG. 21, the horizontal axis of the graph denotes time and the vertical axis of the graph denotes a voltage of an output signal OUT_TGGL. Hereinafter, for a more concise description, it is assumed that the output signal OUT_TGGL has a voltage Vpre before a change in a gray level of a source drive circuit SDC_TGGL, and the voltage of the output signal OUT_TGGL becomes Vpost after a sufficient time has elapsed after the change in the gray level of the source drive circuit SDC_TGGL. In addition, hereinafter, it is assumed that the source drive circuit SDC_TGGL is the farthest disposed source drive circuit from the gamma voltage generator 140, but the range of present disclosure is not limited thereto.

The single-dot chain line graph shows a voltage level of an output signal OUT_TGGL when the display drive circuit 10a is implemented in a 1-gamma block structure. In this case, the output signal OUT_TGGL may reach Vpost at a sixth time point t6.

The dotted-line graph shows a voltage level of the output signal OUT_TGGL when the display drive circuit 10b is implemented in a 2-gamma block structure. In this case, the output signal OUT_TGGL may reach Vpost at a fifth time point t5.

As previously described with reference to FIG. 1 to FIG. 5 and FIG. 19, the solid-line graph shows a voltage level of the output signal OUT_TGGL when the display drive circuit 100 is implemented in a 1-gamma block with 2-GIC structure. In this case, the output signal OUT_TGGL may reach Vpost at a fourth time point t4.

The fourth time point t4 may precede the fifth time point t5, and the fifth time point t5 may precede the sixth time point t6. That is, when the display drive circuit 100 is implemented in the 1-gamma block with 2-GIC structure, the voltage level swing of the victim gamma line GML_victim can be minimized, and therefore, the time required for the source drive circuit SDC_TGGL to generate the intended voltage through the gray level change (e.g., slew length) can be minimized.

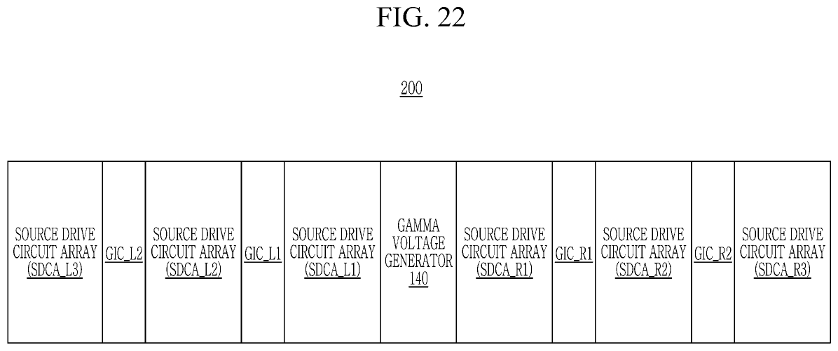

FIG. 22 shows a dispose layout of a display drive circuit according to an embodiment of the present disclosure. Referring to FIG. 22, a display drive circuit 200 may be implemented in a 1-gamma block 4-GIC structure.

A source drive circuit array SDCA_L1 to a source drive circuit array SDCA_L3 may be disposed on the left side of a gamma voltage generator 140. A source drive circuit array SDCA_R1 to a source drive circuit array SDCA_R3 may be disposed on the right side of the gamma voltage generator 140. Each of the source drive circuit arrays SDCA_L1 to SDCA_L3 and SDCA_R1 to SDCA_R3 may include one or more of the first source drive circuit SDC1 to the m-th source drive circuit SDCm.

A gamma line interconnect circuit GIC_L1 may be disposed between the source drive circuit array SDCA_L1 and the source drive circuit array SDCA_L2. A gamma line interconnect circuit GIC_L2 may be disposed between the source drive circuit array SDCA_L2 and the source drive circuit array SDCA_L3.

A gamma line interconnect circuit GIC_R1 may be disposed between the source drive circuit array SDCA_R1 and the source drive circuit array SDCA_R2. A gamma line interconnect circuit GIC_R2 may be disposed between the source drive circuit array SDCA_R2 and the source drive circuit array SDCA_R3.

For a more concise description, in FIG. 21, an output signal OUT_TGGL in the case that a source drive circuit SDC_TGGL is the most distantly disposed from the gamma voltage generator 140 is representatively described, but the scope of the present disclosure is not limited thereto. For example, fourth to sixth voltages t4 to t6 may vary depending on a distance between a certain source drive circuit SDC_TGGL and the gamma voltage generator 140, the size of resistors included in the gamma line interconnect circuit GIC, and the like.

In FIG. 22, for a more concise description, an embodiment in which four gamma line interconnect circuits are disposed for one gamma voltage generator 140 is representatively described, but the range of present disclosure is not limited to the number of gamma line interconnect circuits. For example, the display drive circuit may be implemented in various formats such as a 1-gamma block with 6-GIC structure.

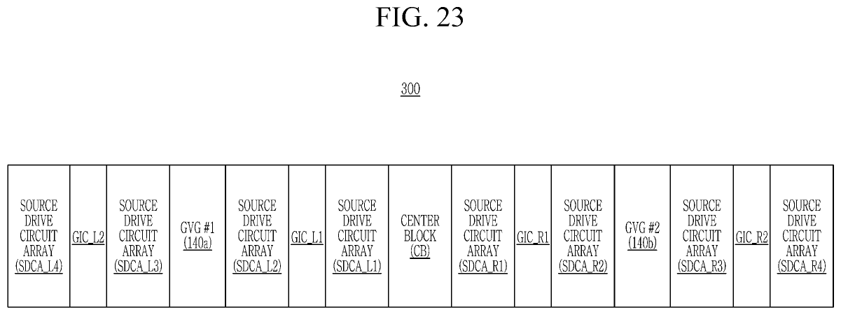

FIG. 23 shows a dispose layout of a display drive circuit according to an embodiment of the present disclosure. Referring to FIG. 23, a display drive circuit 300 may be implemented in a 2-gamma block 4-GIC structure.

A center block CB may be disposed at a center of the display drive circuit 300. For example, the center block CB may include a control logic circuit 110. However, the scope of the present disclosure is not limited thereto.

A first gamma voltage generator 140a may be disposed on the left side of the center block CB. A second gamma voltage generator 140b may be disposed on the right side of the center block CB.

A source drive circuit array SDCA_L3 and a source drive circuit array SDCA_L4 may be disposed on the left side of the first gamma voltage generator 140a. A source drive circuit array SDCA_L1 and a source drive circuit array SDCA_L2 may be disposed between the first gamma voltage generator 140a and the center block CB. The source drive circuit array SDCA_L3 and the source drive circuit array SDCA_L2 may be disposed adjacent to the first gamma voltage generator 140a.

A gamma line interconnect circuit GIC_L2 may be disposed between the source drive circuit array SDCA_L3 and the source drive circuit array SDCA_L4. The gamma line interconnect circuitGIC_L1 may be disposed between the source drive circuit array SDCA_L2 and the source drive circuit array SDCA_L1.

The source drive circuit array SDCA_R3 and the source drive circuit array SDCA_R4 may be disposed on the right side of the second gamma voltage generator 140b. The source drive circuit array SDCA_R1 and the source drive circuit array SDCA_R2 may be disposed between the second gamma voltage generator 140b and the center block CB. The source drive circuit array SDCA_R3 and the source drive circuit array SDCA_R2 may be disposed adjacent to the second gamma voltage generator 140b.

A gamma line interconnect circuit GIC_R2 may be disposed between the source drive circuit array SDCA_R3 and the source drive circuit array SDCA_R4. A gamma line interconnect circuit GIC_R1 may be disposed between the source drive circuit array SDCA_R2 and the source drive circuit array SDCA_R1.

In FIG. 23, for a more concise description, an embodiment in which four gamma line interconnect circuits are disposed for two gamma voltage generators is representatively described, but the range of present disclosure is not limited to the number of gamma voltage generators and gamma line interconnect circuits.

FIG. 24 shows a configuration of a gamma line interconnect circuit according to another embodiment of the present disclosure. Referring to FIG. 5 and FIG. 24, a gamma line interconnect circuit GIC in FIG. 1 may correspond to a gamma line interconnect circuit GIC_2 illustrated in FIG. 24. The gamma line interconnect circuit GIC_2 may include a first switch SW1 to an (n-1)-th switch SWn-1 and a first resistor R1 to an (n-1) th resistor Rn-1. The first switch SW1 to the (n-1)-th switch SWn-1 and the first resistor R1 to the (n-1)-th resistor Rn-1 may be respectively connected between a first gamma line GML1 to an n-th gamma line GMLn. For example, a first switch SW1 and a first resistor R1 may be connected in series between the first gamma line GML1 and the second gamma line GML2, and a second switch SW2 and a second resistor R2 may be connected in series between a second gamma line GML2 and a third gamma line GML3. In this way, the n-1 th switch SWn-1 and the n-1 th resistor Rn-1 may be connected in series between the n-1 th gamma line GMLn-1 and the n-th gamma line GMLn.

The first switch SW1 to the (n-1) th switch SWn-1 may operate in response to an interconnect signal ICN. For example, the first switch SW1 to the (n-1)-th switch SWn-1 may be turned on when the interconnect signal ICN is at a logic high state and may be turned off when the interconnect signal ICN is at a logic low state. That is, the gamma line interconnect circuit GIC may operate in a coarse restore mode or a fine restore mode in response to the logic level of the interconnect signal ICN. In this case, a voltage level swing of a victim gamma line GML_victim can be minimized. A time at which the logic level of the interconnect signal ICN transitions is is similar to that described with reference to FIG. 1 to FIG. 8, and therefore a detailed description will be omitted.

The above description is specific embodiments for carrying out the present disclosure. The present disclosure will include not only the above-described embodiments, but also embodiments that can be simply changed in design or easily changed. In addition, the present disclosure will also include techniques that can be easily modified and implemented using the disclosed embodiments. Therefore, the scope of the present disclosure should not be limited to the above-described embodiments and should be defined by the claims range to be described later as well as those equivalent to the claims range of the present disclosure.

1. A gamma line interconnect circuit comprising:
a resistor string comprising a first resistor connected between a first node and a second node and a second resistor connected between the second node and a third node;
a first switch connected between a first gamma line and the first node, and configured to operate based on an interconnect signal;
a second switch connected between a second gamma line and the second node, and configured to operate based on the interconnect signal; and
a third switch connected between a third gamma line and the third node, and configured to operate based on the interconnect signal.

2. The gamma line interconnect circuit of claim 1, wherein:
each of the first switch, the second switch, and the third switch is turned on when the interconnect signal is at a logic high state, and
each of the first switch, the second switch, and the third switch is turned off when the interconnect signal is at a logic low state.

3. The gamma line interconnect circuit of claim 2, wherein:
the interconnect signal transitions to the logic high state at a first time point, when a gray level value provided to a first source drive circuit connected with the first gamma line, the second gamma line, and the third gamma line is changed.

4. The gamma line interconnect circuit of claim 3, wherein:
the interconnect signal transitions to the logic low state at a second time point after a first time period elapses from the first time point.

5. The gamma line interconnect circuit of claim 4, wherein:
after the first time point, the first source drive circuit operates based on a voltage level of the first gamma line.

6. The gamma line interconnect circuit of claim 5, wherein:
at a third time point after a second time period elapses from the second time point, the voltage level of the first gamma line reaches a voltage level that is equal to the voltage level of the first gamma line before the first time point.

7. The gamma line interconnect circuit of claim 6, wherein:
the first time period is greater than the second time period.

8. The gamma line interconnect circuit of claim 4, further comprising:
a first current provide circuit connected to the first node and configured to operate between the first time point and the second time point;
a second current provide circuit that is connected to the second node and configured to operate between the first time point and the second time point; and
a third current provide circuit that is connected to the third node and configured to operate between the first time point and the second time point.

9. The gamma line interconnect circuit of claim 1, wherein:
the first node is configured to receive a first hold voltage through a first hold line, and
the third node is configured to receive a second hold voltage through a second hold line.

10. The gamma line interconnect circuit of claim 9, wherein:
a voltage level of the first hold voltage corresponds to a voltage level of the first gamma line, and
a voltage level of the second hold voltage corresponds to a voltage level of the third gamma line.

11. The gamma line interconnect circuit of claim 1, wherein:
the first gamma line, the second gamma line, and the third gamma line are connected to an output node of different gamma amplifiers each other.

12. A display drive circuit comprising:
a source drive circuit controlling a display panel;
a gamma voltage generator respectively providing a first to N-th gamma voltages to a first to N-th gamma lines connected to the source drive circuit, wherein N is an integer greater than 2; and
a gamma line interconnect circuit interconnecting the first to N-th gamma lines for a first time period from a first time point when a gray level value of the source drive circuit is changed.

13. The display drive circuit of claim 12, wherein:
the gamma line interconnect circuit comprises:
first to N-th switches connected between the first to N-th gamma lines and first to N-th nodes, respectively; and
a resistor string that comprises a first to (N-1)-th resistors connected between pairs of adjacent nodes from among the first to N-th nodes, respectively.

14. The display drive circuit of claim 13, wherein:
each of the first to N-th switches is configured to:
be turned on during a first time period from the first time point to a second time point, and
be turned off before the first time point and after the second time point.

15. The display drive circuit of claim 14, wherein:
a first resistance-capacitance time constant between the source drive circuit and the gamma voltage generator during the first time period between the first time point and the second time point is less than a second resistance-capacitance time constant between the source drive circuit and the gamma voltage generator after the second time point.

16. The display drive circuit of claim 13, wherein:
the gamma voltage generator comprises:
a first gamma amplifier configured to output a first gamma voltage to a first tap node connected to a first gamma line;
a second gamma amplifier configured to output the N-th gamma voltage to a second tap node connected to the N-th gamma line; and
a divider circuit connected between the first tap node and the second tap node, and configured to output the second to (N-1)-th gamma voltages.

17. The display drive circuit of claim 16, wherein:
the first node is connected to the first tap node through a first hold line, and the second node is connected to the second tap node through a second hold line.

18. The display drive circuit of claim 16, wherein:
the gamma voltage generator further comprises:
a first dummy gamma amplifier configured to provide a first dummy voltage corresponding to the first gamma voltage to the first node; and
a second dummy gamma amplifier configured to provide a second dummy voltage corresponding to the N-th gamma voltage to the N-th node.

19. A display device comprising:
a display panel comprising a first plurality of pixels and a second plurality of pixels; and
a display drive circuit configured to control the first plurality of pixels and the second plurality of pixels,
wherein the display drive circuit comprises:
a gamma voltage generator providing different gamma voltages to a plurality of gamma lines;
a first source drive circuit array connected with the plurality of gamma lines, and comprising a first plurality of source drive circuits configured to control the first plurality of pixels;
a second source drive circuit array connected with the plurality of gamma lines, and comprising a second plurality of source drive circuits configured to control the second plurality of pixels; and
a gamma line interconnect circuit located between the first source drive circuit array and the second source drive circuit array, and interconnecting the plurality of gamma lines during a predetermined time period after a change in one or more gray level values of the first plurality of source drive circuits and the second plurality of source drive circuits.

20. The display device of claim 19, wherein:
the gamma line interconnect circuit comprises:
a resistor string; and
a plurality of switches respectively connected between one of a plurality of nodes included in the resistor string and one of the plurality of gamma lines; and
each of the plurality of switches is turned on during a time period from a first time point to a second time point, and turned off before the first time point and after the second time point.

21. (canceled)
